(19) United States
(12) Patent Application Publication
(10) Pub. No.: US 2007/0016563 A1
(43) Pub. Date: Jan. 18, 2007

(54) INFORMATION NERVOUS SYSTEM

(76) Inventor: Nosa Omoigui, Redmond, WA (US)

Correspondence Address: BLACK LOWE & GRAHAM, PLLC, 701 FIFTH AVENUE, SUITE 4800, SEATTLE, WA, 98104, US

(21) Appl. No.: 11/383,736

(22) Filed: May 16, 2006

Related U.S. Application Data
(60) Provisional application No. 60/681,892, filed on May 16, 2005.

(51) Int. Cl. G06F 17/30

(52) U.S. Cl. 707/3

(57) ABSTRACT

A system includes a server programmable to maintain semantic information and/or a client providing a user interface for a user to communicate with the server. In an embodiment, the processor of the server operates to secure information from information sources, semantically ascertain one or more semantic properties of the information, and/or respond to user queries based upon one or more of the semantic properties.

### PRIORITY CLAIM

This application claims priority to U.S. Provisional Patent Application No. 60/681,892 filed May 16, 2005. U.S. patent application Ser. No. 11/127,021 filed May 10, 2005; which application claims priority to U.S. Provisional Application Ser. Nos. 60/569,663 (Attorney Docket No. NERV-1-1007) and/or U.S. Provisional Application Ser. No. 60/569,665 (Attorney Docket No. NERV-1-1008).

This application claims priority to U.S. application Ser. No. 10/179,651 (Attorney Docket No. FORE-1-1001) filed Jun. 24, 2002, which application claims priority to U.S. Provisional Application No. 60/360,610 (Attorney Docket No. NERV-1-1003) filed Feb. 28, 2002 and/or to U.S. Provisional Application No. 60/300,385 (Attorney Docket No. FORE-1-1002) filed Jun. 22, 2001. This Application also claims priority to U.S. Provisional Application No. 60/447,736 (Attorney Docket No. NERV-1-1004) filed Feb. 14, 2003. This Application also claims priority to PCT/US02/20249 (Attorney Docket No. FORE-11-1001) filed Jun. 24, 2002.

This application claims priority to U.S. application Ser. No. 10/781,053 (Attorney Docket No. NERV-1-1006) filed Feb. 17, 2004, which application is a Continuation-In-Part of U.S. application Ser. No. 10/179,651 filed Jun. 24, 2002, which claims priority to U.S. Provisional Application No. 60/360,610 filed Feb. 28, 2002 and/or to U.S. Provisional Application No. 60/300,385 filed Jun. 22, 2001. This Application also claims priority to U.S. Provisional Application No. 60/447,736 filed Feb. 14, 2003. This Application also claims priority to PCT/US02/20249 filed Jun. 24, 2002. This Application also claims priority to PCT/US2004/004380 (Attorney Ref. No. NERV-11-1012) and/or U.S. application Ser. No. 10/779,533 (Attorney Ref. No. NERV-1-1005), both filed Feb. 14, 2004.

This application claims priority to PCT/US04/004674 (Attorney Docket No. NERV-11-1013) filed Feb. 14, 2004, which application is a Continuation-In-Part of U.S. Application Ser. No. 10/179,651 filed Jun. 24, 2002, which claims priority to U.S. Provisional Application No. 60/360,610 filed Feb. 28, 2002 and/or to U.S. Provisional Application No. 60/300,385 filed Jun. 22, 2001. This Application also claims priority to U.S. Provisional Application No. 60/447,736 filed Feb. 14, 2003. This Application also claims priority to PCT/US02/20249 filed Jun. 24, 2002. This Application also claims priority to PCT/US2004/004380 (Attorney Ref. No. NERV-11-1012) and/or U.S. application Ser. No. 10/779,533 (Attorney Ref. No. NERV-1-1005), both filed Feb. 14, 2004.

All of the foregoing applications are hereby incorporated by reference in their entirety as if fully set forth herein.

### COPYRIGHT NOTICE

This disclosure is protected under United States and/or International Copyright Laws. © 2002-2006 Nosa Omoigui. All Rights Reserved. A portion of the disclosure of this patent document contains material which is subject to copyright protection. The copyright owner has no objection to the facsimile reproduction by anyone of the patent document or the patent disclosure, as it appears in the Patent and/or Trademark Office patent file or records, but otherwise reserves all copyright rights whatsoever.

### BACKGROUND OF THE INVENTION

The explosive growth of digital information is increasingly impeding knowledge-worker productivity due to information overload. Online information is virtually doubling every year and/or most of that information is unstructured—usually in the form of text. Traditional search engines have been unable to keep up with the pace of information growth primarily because they lack the intelligence to “understand,” semantically process, mine, infer, connect, and/or contextually interpret information in order to transform it to—and/or expose it as—knowledge. Furthermore, end-users want a simple yet powerful user-interface that allows them to flexibly express their context and/or intent and/or be able to “ask” natural questions on the one hand, but which also has the power to guide them to answers for questions they wouldn't know to ask in the first place. Today's search interfaces, while easy-to-use, do not provide such power and/or flexibility.

Now that the Web has reached critical mass, the primary problem in information management has evolved from one of access to one of intelligent retrieval and/or filtering. Computer users are now faced with too much information, in various formats and/or via multiple applications, with little or no help in transforming that information into useful knowledge.

Search engines such as Google™ provide some help in filtering information by indexing content based on keywords. Google™, in particular, has gone a step further by mining the hypertext links in Web pages in order to draw inferences of relevance based on page popularity. These techniques, while helpful, are far from sufficient and/or still leave end-users with little help in separating wheat from chaff. The primary reason for this is that current search engines do not truly “understand” what they index or what users want. Keywords are very poor approximations of meaning and/or user intent. Furthermore, popularity, while useful, is no guarantee of relevance: Popular garbage is still garbage.

Furthermore, knowledge has multiple axes, and/or search is only one of those axes. Knowledge-workers also wish to discover information they might not know they need ahead of time, share information with others (especially those that have similar interests), annotate information in order to provide commentary, and/or have information presented to them in a way that is contextual, intuitive, and/or dynamic—allowing for further (and/or potentially endless) exploration and/or navigation based on their context. Even within the search axis, there are multiple sub-axes, for instance, based on time-sensitivity, semantic-sensitivity, popularity, quality, brand, trust, etc. The axis of choice depends on the scenario at hand.

Search engines are appropriately named because they focus on search. However, merely improving search quality without reformulating the core goal of search will leave the information overload problem unaddressed.

### BRIEF DESCRIPTION OF THE DRAWINGS

FIG. 1 illustrates defined knowledge filters/types, in accordance with an embodiment of the invention.

FIG. 2 is a sample illustration of a user-defined hierarchy for storing personal digital photos.

FIG. 3 illustrates sample fields of the Knowledge Domain Entry data structure returned by the KDS Web in accordance with an embodiment of the invention.

FIG. 4 illustrates the schema and/or sample fields of a KDS result, in accordance with an embodiment of the invention.

FIG. 5 illustrates the representation of a semantic network in the KIS, in accordance with an embodiment of the invention.

FIG. 6 illustrates the schema and/or sample fields of a category that gets added to the semantic network, in accordance with an embodiment of the invention.

FIG. 7 illustrates the end-to-end architecture of one embodiment of the invention.

FIG. 8 illustrates the representation of a semantic network in accordance with an embodiment of the invention.

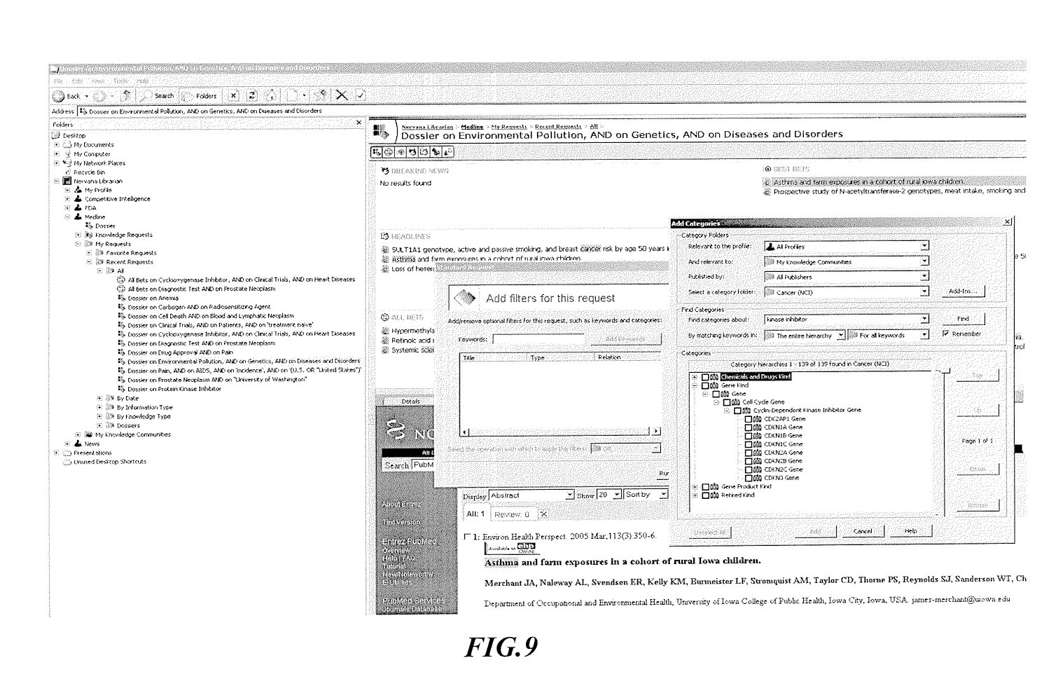

FIG. 9 is a screenshot of a search conducted in accordance with an embodiment of the invention.

FIGS. 10 and/or 11 illustrate sample queries of one embodiment of the invention.

FIG. 12 is an illustrative example of a pagination pipeline architecture diagram in accordance with an embodiment of the invention.

FIG. 13 is a block diagram illustrating General Content Transformation Pipeline Architecture in accordance with an embodiment of the invention.

FIG. 14 shows a visual of semantic highlighting in accordance with an embodiment of the invention.

FIG. 15 is a screenshot showing additional KIS Features via KC Properties Dialog Box in accordance with an embodiment of the invention.

FIG. 16 shows a screenshot Showing UI for Browsing Ontologies (Category Folders) in a User Profile (or KC) in accordance with an embodiment of the invention.

FIG. 17 shows an illustration of the implementation of the feature, the well-known knowledge stack, and/or how this applies to this model in accordance with an embodiment of the invention.

FIG. 18 illustrates what many Web users goes through today while trying to browse the World Wide Web.

FIG. 19 shows the user-interface for installing and/or uninstalling Category Folder add-ins in accordance with an embodiment of the invention.

FIG. 20 illustrates display of statistics in accordance with an embodiment of the invention.

FIG. 21 illustrates a system in accordance with an embodiment of the invention.

### DETAILED DESCRIPTION OF THE PREFERRED EMBODIMENT

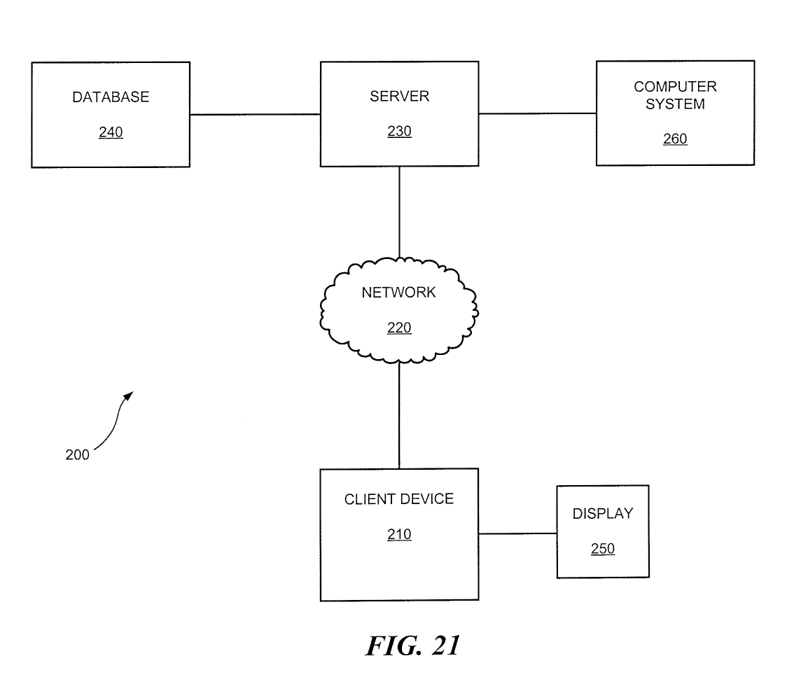

Referring to FIG. 21, an embodiment of the present invention can be described in the context of an exemplary computer network system 200 as illustrated. System 200 includes an electronic client device 210, such as a personal computer or workstation, that is linked via a communication medium, such as a network 220 (e.g., the Internet), to an electronic device or system, such as a server 230. The server 230 may further be coupled, or otherwise have access, to a database 240 and/or a computer system 260. Although the embodiment illustrated in FIG. 21 includes one server 230 coupled to one client device 210 via the network 220, it should be recognized that embodiments of the invention may be implemented using one or more such client devices coupled to one or more such servers.

In an embodiment, each of the client device 210 and/or server 230 may include all or fewer than all of the features associated with a modern computing device. Client device 210 includes or is otherwise coupled to a computer screen or display 250. As is well known in the art, client device 210 can be used for various purposes including both network- and/or local-computing processes.

The client device 210 is linked via the network 220 to server 230 so that computer programs, such as, for example, a browser, running on the client device 210 can cooperate in two-way communication with server 230. Server 230 may be coupled to database 240 to retrieve information therefrom and/or to store information thereto. Database 240 may include a plurality of different tables (not shown) that can be used by server 230 to enable performance of various aspects of embodiments of the invention. Additionally, the server 230 may be coupled to the computer system 260 in a manner allowing the server to delegate certain processing functions to the computer system.

An end-to-end system and/or resulting knowledge medium, which may be regarded and/or referred to as an Information Nervous System, addresses the problems described herein. An embodiment of the system provides intelligent and/or dynamic semantic indexing and/or ranking of information (without requiring formal semantic markup), along with a semantic user interface that provides end-users with the flexibility of natural-language queries (without the limitations thereof), without sacrificing ease-of-use, and/or which also empowers users with dynamic knowledge retrieval, capture, sharing, federation, presentation and/or discovery—for cases where the user might not know what she doesn't know and/or wouldn't know to ask.

A system according to an embodiment of the invention understands what it indexes, empowers users to be able to flexibly express their intent simply yet precisely, and/or interprets that intent accurately yet quickly. A system according to an embodiment of the invention blends multiple axes for retrieval, capture, discovery, annotations, and/or presentation into a unified medium that is powerful yet easy to use.

A system according to an embodiment of the invention provides end-to-end functionality for semantic knowledge retrieval, capture, discovery, sharing, management, delivery, and/or presentation. The description herein includes the philosophical underpinnings of an embodiment of the invention, a problem formulation, a high-level end-to-end architecture, and/or a semantic indexing model. Also included, according to an embodiment of the invention, is a system's semantic user interface, its Dynamic Linking technology, its semantic query processor, its semantic and/or context-sensitive ranking model, its support for personalized context, and/or its support for semantic knowledge sharing all of which an embodiment employs to provide a semantic user experience and/or a medium for knowledge.

Further described herein are an overview of the difference between knowledge and/or information and/or how that should apply to an intelligent information retrieval system; the problem with Search, as is currently defined and/or implemented by current search engines; context and/or semantics especially on the limitations of current search engines and/or retrieval paradigms and/or the implications on the design of an intelligent information retrieval system; the Semantic Web and/or Metadata and/or describes how these initiatives relate to the design of an intelligent information retrieval system and/or also how they may be placed in perspective from a practical standpoint; the problems and/or limitations of current search interfaces; Semantic Indexing in general, how this relates to an intelligent information retrieval system, and/or on Dynamic Semantic Indexing as designed and/or implemented in the Information Nervous System, in accordance with at least one embodiment of the invention.

Intelligent Retrieval: Knowledge vs. Information. An intelligent information retrieval system, according to an embodiment of the invention, simulates a human reference librarian or research assistant. A reference librarian is able to understand and/or interpret user intent and/or context and/or is able to guide the user to find precisely what she wants and/or also what she might want. An intelligent assistant not only may help the user find information but also assists the user in discovering information. Furthermore, an intelligent assistant may be able to converse with the user in order to enable the user to further refine the results, explore or drill-down the results, or find more information that is semantically relevant to the results.

An intelligent information retrieval system, according to an embodiment of the invention, may allow users to find knowledge, rather than information. Knowledge may be considered information infused with semantic meaning and/or exposed in a manner that is useful to people along with the rules, purposes and/or contexts of its use. Consistent with this definition (and/or others), knowledge, unlike information or data, may be based on context, semantics, and/or purpose. Today's search engines have none of these three elements and/or, as a consequence, are fundamentally unequipped to deal with the problem of information overload.

In an embodiment, a retrieval system blends search and/or discovery for scenarios where the user does not even know what to search for in the first place. Searching for knowledge is not the same as searching for information. An intelligent search engine according to an embodiment of the invention allows a user to search with different knowledge filters that encapsulate semantic-sensitivity, time-sensitivity, context-sensitivity, people (e.g., experts), etc. These filters may employ different ranking schemes consistent with the natural equivalent of the filter (e.g., a search for Best Bets may rank results based on semantic strength, a search for Breaking News may rank results based primarily on time-sensitivity, while a search for Experts may rank results based primarily on expertise level). These form context themes or templates that can guide the user to quickly find what she wants based on the scenario at hand.

For example, a user might want only latest (but also highly semantically relevant) information on a certain topic (perhaps because she is short on time and/or is preparing for a presentation that is due shortly)—this may be the equivalent of Breaking News. Or the user might be conducting research and/or might want to go deep—she might be interested in information that is of a very high level of semantic relevance. Or the user might want to go broad because she is exploring new topics of interest and/or is open to many possibilities. Or the user might be interested in relevant people on a given topic (communities of interest, experts, etc.) rather than—or in addition to—information on that topic. These are all valid but different real-world scenarios. An embodiment of the invention supports all these semantic axes in a consistent way yet exposes them separately so the user knows in what context the results are being displayed in order to aid him or her in interpreting the results.

Expressed formulaically, today's search engines allow users to find i, where i represents information. In contrast, an embodiment of the invention allows users to find K, where K represents knowledge.

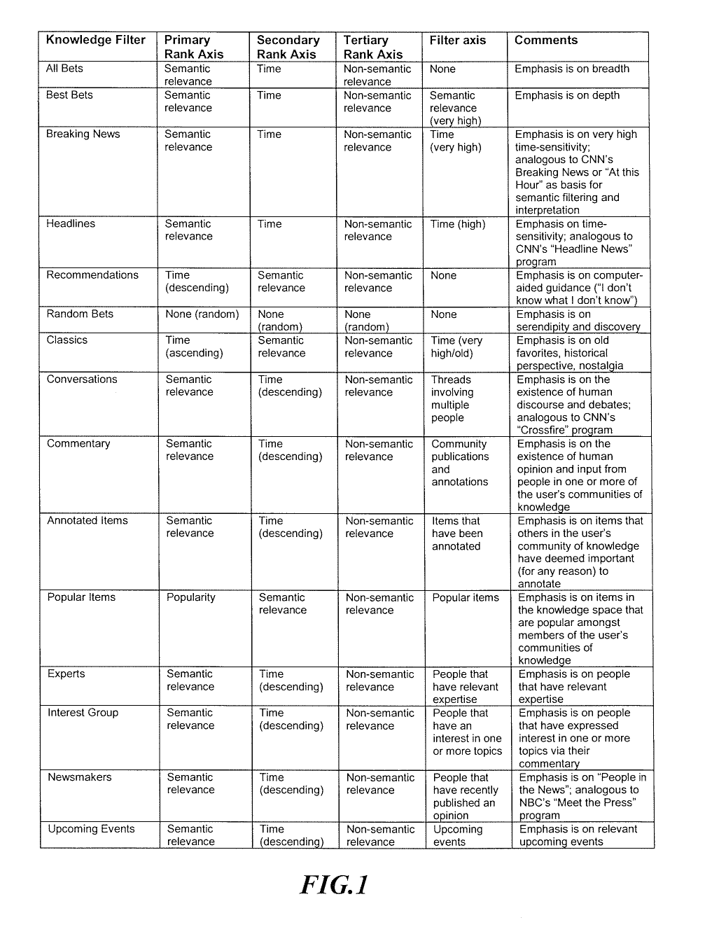

An embodiment of the invention allows for knowledge-based retrieval (expressed above as K) via knowledge filters (which may also be referred to as special agents or knowledge requests), each corresponding to a knowledge type. FIG. 1 illustrates defined knowledge filters/types in accordance with an embodiment of the invention. As used therein, the term “debates” may be an indication of semantic emphasis due to the participation of multiple individuals with potentially diverse viewpoints. Additionally, as an illustration, an Interest Group might include those that have questions (knowledge-seekers) and/or not just those that have answers (knowledge-providers or experts). This filter may connect both constituencies.

The ranking axes can be further refined and/or configured on the fly, based on user preferences. An embodiment of the invention also defines a special knowledge filter, a Dossier, which encapsulates every individual knowledge filter. A Dossier allows the user to retrieve comprehensive knowledge from one or more sources on one or more optional contextual filters, using one or more of the individual knowledge filters. For instance, in Life Sciences, a Dossier on Cardiovascular Disorder may be semantically processed as All Bets on Cardiovascular Disorder, Best Bets on Cardiovascular Disorder, Experts on Cardiovascular Disorder, etc. A Dossier may be akin to a “super knowledge-filter” and/or may be very powerful in that it can combine search and/or discovery via the different knowledge filters and/or allows users to retrieve knowledge in different contexts.

In an embodiment of the invention, the system's model of knowledge filters and/or Dossiers has several interesting side-effects. First, it insulates the system from having to provide perfect ranking on any given axis before it can be of value to the user. The combination of multiple ranking and/or filtering axes guides the user to find what she wants via multiple semantic paths. As such, each semantic path becomes more effective when used in concert with other semantic paths in order to reach the eventual destination. Furthermore, an embodiment of the invention introduces Dynamic Linking, which allows the user to navigate multiple semantic paths recursively. This allows the user to navigate the knowledge space from and/or across multiple angles and/or perspectives, while iterating these perspectives potentially endlessly. This further allows the user to browse a dynamic, personal web of context as opposed to a web of pages or even a pre-authored semantic web which would still be author-centric rather than user-centric.

As an illustration, an embodiment of the invention allows a user to find Breaking News on a topic, then navigate to Experts on that Breaking News, then navigate to people that share the same Interest Group as those Experts, then navigate to what those people wrote, then navigate to Best Bets relevant to what they wrote, then navigate to Headlines relevant to those Best Bets, then navigate to Newsmakers on those headlines, etc. The user is able to navigate context and/or perspectives on the fly. Just as the Web empowers users to navigate information, an embodiment of the invention empowers users to navigate knowledge.

An embodiment of the invention also defines information types, which may be semantic versions of well-known object and/or file types. These may include Documents (General Documents, Presentations, Text Documents, Web Pages, etc.), Events (Meetings, etc.), People, Email Messages, Distribution Lists, etc.

Context and/or Semantics. As described herein, an embodiment of the invention is able to interpret the context and/or semantics of a user's query and/or also allows the user to express his or her intent via multiple contexts.

The Problem with Keywords. To mimic the intelligent behavior exhibited by a human research assistant or reference librarian, an embodiment of the invention first is able to “understand” what it stores and/or indexes. Today's search engines do not know the difference between keywords when those keywords are used in different contexts. For instance, the word “bank” means very different things when used in the context of a commercial bank, river bank, or “the sudden bank of an airplane.” Even within the same knowledge domain, the problem still applies: for instance in the Life Sciences domain, the word “Cancer” could refer to the disease, the genetics of the disease, the pain related to the disease, technologies for preventing the disease, the metaphor, the epidemic, or the public policy issue. The inability of search engines to make distinctions based on semantics and/or context is one of the causes of information overload because users must then manually filter out thousands or millions of irrelevant results that have the right keywords but in the wrong context (false positives).

An embodiment of the invention also is able to retrieve information that doesn't have the user's expressed keywords but which is semantically relevant to those keywords. This would address the false negatives problem—wherein search engines leave out results that they deem irrelevant only because the results don't contain the “right” keywords. For instance, the word “bank” and/or the phrase “financial institution” are semantically very similar in the domain of financial services. An embodiment of the invention is able to recognize this and/or return the right results with either set of keywords.

Today's search engines are also unable to understand semantic queries like “Find me technical articles on Security” (in the Computer Science domain). A semantic search for “Technical Articles on Security” is not the same as a Google™ search for “technical”+“articles”+“security” or even “technical articles”+“security.” A semantic search for “Technical Articles on Security” also returns, for example, Bulletins on Encryption, White Papers on Cryptography, and/or Research Papers on Key Management. These queries are all semantically equivalent to “Technical Articles on Security” even though they all contain different keywords. Furthermore, a semantic search for “Technical Articles on Security” does not return results on physical or corporate security, vaults or safes.

As queries get more complex, the distinction between a keyword search and/or an intelligent search grows exponentially. For example, in the Life Sciences domain, a semantic search for “Research Reports on Cardiovascular Disorder and/or Protein Engineering and/or Neoplasm and/or Cancer” is far from being the same as a keyword search for “research reports”+“cardiovascular disorder”+“protein engineering”+“neoplasm”+“cancer.” For example, from a user's standpoint, “Research Reports on Cardiovascular Disorder and/or Protein Engineering and/or Neoplasm and/or Cancer” also returns technical articles that are relevant to Hypervolemia (which is semantically related to Cardiovascular Disorder but has different keywords) and/or which are also relevant to Amino Acid Substitution (which is a form of Protein Engineering), and/or which are also relevant to Minimal Residual Disease (which is a form of Neoplasm and/or Cancer). The exponential growth of information combined with an exponential divergence in semantic relevance as queries become more complex could inevitably lead to a situation where information while plentiful, loses much of its value due to the absence of semantic and/or contextual filtering and/or retrieval.

Other forms of context. As described above, today's search engines do not semantically interpret keywords. However, even if they did, this will not be sufficient for an intelligent information retrieval system because keywords are only one of many forms of context. In the real-world, context exists in many forms such as documents, local file-folders, categories, blobs of text (e.g., sections of documents), projects, location, etc. For instance, in an embodiment, a user is able to use a local document (or a document retrieved off the Web or some other remote repository) as context for a semantic query. This greatly enhances the user's productivity—using prior technologies, the user has to manually determine the concepts in the documents and/or then map those concepts to keywords. This is either impossible or very time-consuming. In an embodiment, users are able to choose categories from one or more taxonomies (corresponding to one or more ontologies) and/or use those categories as the basis for a semantic search. Furthermore, in an embodiment, users are able to dynamically combine categories from the same taxonomy (or from multiple taxonomies) and/or cross-reference them based on their context.

An embodiment of the invention also allows users to combine different forms of context to match the user's intent as precisely as possible. For example, a user is able to find semantically relevant knowledge on a combination of categories, keywords, and/or documents, if such a combination (applied with a Boolean operator like OR or AND/OR) accurately captures the user's intent. Such flexibility is possible rather than forcing the user to choose a specific form of context that might not have the correct level of richness or granularity corresponding to his or her intent.

Expressed formulaically, an embodiment of the invention combines multiple knowledge axes (as described in section 3 above) with multiple forms of context to allow the user to find K(X), where K is knowledge and/or X represents different forms of context with varying semantic types and/or levels of richness—for instance, documents, keywords, categories, or a combination thereof.

The Problem with Google™. Google™ employs a technology called PageRank to address the keywords problem. PageRank ranks web pages based on how many other pages link to each page. This is a very clever technique as it attempts to infer meaning based on human judgment as to which pages are important relative to others. Furthermore, the technique does not rely on formal semantic markup or metadata, which is optionally advantageous in making the model practical and/or scaleable. However, ranking pages based on popularity also has problems. First, without semantics or context, popularity has very little value. To take the examples cited above, “Technical Articles on Security” (to a computer scientist) is not semantically equivalent to “Popular Pages on Bank Vaults or Safes.” The popularity of the returned results is irrelevant if the context of the user's query is not intelligently interpreted—if the results are meaningless, that they might be popular makes no difference.

Second, PageRank relies on the presence of links to infer meaning. While this works relatively well in an organic, Hypertext environment such as the Web, it is ineffective in business environments where majority of the documents do not have links. These include Microsoft Office documents, PDF documents, email messages, and/or documents in content management systems and/or databases. The scarcity (or absence) of links in most of these documents implies that PageRank would have no data with which to rank. In other words, if every document in the world were a PDF with no links, all documents may have a Page Rank of 0 and/or may be ranked equally. This then degenerates to a regular keyword search.

Third, popularity is only one contextual or ranking axis. In contrast, in the real-world there are multiple axes by which users acquire knowledge. Popularity is one but there are others including time-sensitivity (e.g., Breaking News or Headlines), annotations (indicating that others have taken the time to comment on certain documents), experts (which is a semantic axis via which users can navigate to authoritative information), recommendations (based on collaborative filtering or the user's interests), etc. An embodiment of the invention allows for the seamless integration of all these axes to provide the user a comprehensive set of perspectives relevant to his or her query.

Fourth, Google™ relies on a centralized index of the Web. The index itself is based on disparate content sources and/or is distributed across many servers but the user “sees” only one index. However, in the real-world (especially in enterprise environments), knowledge is fragmented into silos. These silos include security silos (that restrict access based on the current user) and/or semantic silos (in which different knowledge-bases employ different ontologies which could interpret the same context differently). These silos call for Dynamic Knowledge Federation and/or Semantic Interpretation, not centralization. In an embodiment, the same piece of context is able to “flow” across different semantic silos, get interpreted locally (at each silo) and/or then generate results which then get synthesized dynamically. Furthermore, a user is able to seamlessly integrate results from different silos for which he/she has access (even if that access is mediated via different security credentials). This insulates the user from having to search each silo separately thereby allowing him or her focus on the task at hand.

Expressed formulaically, applying federation to the problem formulation and/or model definition, an embodiment is the triangulation of multiple knowledge axes via multiple optional context types semantically federated from multiple knowledge sources—i.e., K(X) from S1 . . . Sn, where K is knowledge, X is optional context (of varying types), and/or Sn is a knowledge index from source n that incorporates semantics. This model is potentially orders of magnitude more powerful than today's search model which only provides i(x) from s, where i is information (and/or on only one axis; usually relevance or time), x is context (and/or of only one type—keywords, and/or which does not incorporate semantics), and/or s represents one index that lacks semantics and/or is not semantically federated with other silos.

The Problem with Directories and/or Taxonomies. Directories and/or taxonomies can be very useful tools in helping users organize and/or find information. Users employ folders in file-systems to organize their documents and/or pictures. Similar folders exist in email clients to assist users in organizing their email. Many portal products now offer categorization tools that automatically file indexed documents into directories using predefined taxonomies. However, as the volume of information users must deal with continues to skyrocket, directories become ineffective. This happens for several reasons: First, at “publishing time,” users manually create and/or maintain folders and/or subfolders and/or manually assign documents and/or email messages to these folders. This process not only takes a lot of time and/or effort, it also assumes that there is a 1:1 correspondence of item to folder. At a semantic level, the same item could “belong” to different folders and/or categories at the same time. Tools that employ machine learning techniques to aid users in assigning categories also suffer from the same problem.

Second, there is no perfect way to organize an information hierarchy. While users have the flexibility to create their own hierarchies on their computers, problems arise when they need to merge directories from other computers or when there are shared directories (for instance, on file shares). Shared directories are particularly problematic because an administrator typically has to design the hierarchy and/or such a design might be confusing to some or all users that need to find information using that hierarchy.

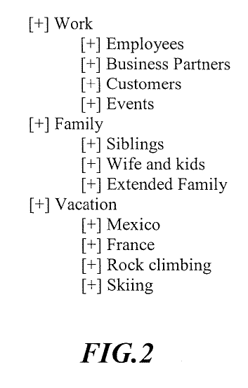

Third, at “retrieval time,” users are forced to “fit” their question or intent to the predefined hierarchy. However, in the real-world, questions are typically much more fuzzy, dynamic, and/or flexible and/or they occasionally involve cross-references. As illustrated in FIG. 2, a user might create a hierarchy for digital photos on his/her computer. This hierarchy might be sufficient up to a certain volume of information. However, as more and/or more pictures accumulate on the user's computer, the user might want to ask complex queries such as: “Find me all pictures I took with my family and/or employees while skiing in France.” Because of the static, inflexible nature of the hierarchy, such a query becomes impossible because the specific context the user wants is not distinctly represented in the directory.

This problem becomes exacerbated in the online world with millions and/or billions of documents and/or hundreds and/or thousands of taxonomy categories. As an illustration, taxonomies in the Pharmaceuticals industry typically have tens of thousands of categories and/or are slow-changing. As such, the impact of the inflexibility of taxonomies and/or directories (which in turn leads to the preclusion of flexible semantic queries and/or search permutations) becomes exponentially worse as information volumes grow and/or also as taxonomies become larger. Users need the flexibility of cross-referencing categories in a taxonomy/ontology on the fly, and/or need to be able to cross-reference topics across taxonomies/ontologies. Research is fluid. Context is dynamic. Topics come and/or go. An embodiment of the invention captures this fluidity by allowing users to flexibly “ask” very natural-like questions, possibly involving dynamic permutations of concepts and/or topics, without the limitations of full-blown natural-language processing.

Applying this to the model definition, given the formulation K(X) from S1 . . . Sn, the ideal model allows X to include dynamic permutations of context of different types. In other words, X is not only of multiple types, it also includes flexible combinations and/or cross-references of those types.

The Semantic Web and/or Metadata. As described herein, a first step in developing an embodiment of the invention is incorporating meaning into information and/or information indexes. In its simplest form, this is akin to creating an organized, meaning-based digital library out of unorganized information. The Worldwide Web Consortium (W3C) has proposed a set of standards, under the umbrella term the “Semantic Web,” for tagging information with metadata and/or semantic markup in order to infuse meaning into information and/or in order to make information easier for machines to process. The Semantic Web effort also includes standards to creating and/or maintaining ontologies which, in the context of information retrieval, are libraries and/or tools that help users formally express what information concepts mean and/or which also help machines disambiguate keywords and/or interpret them in a given domain of knowledge.

The Semantic Web is an initiative in that it may encourage information publishers to tag their content with more metadata in order to make such content easier to search. Furthermore, standards for ontology development and/or maintenance are useful in the establishment of systems that allow publishers to assert or interpret meaning. However, metadata has many problems, especially relating to the need for discipline on the part of publishers. Generally, history has shown that most publishers (including end-users who author Web pages, blogs, documents, etc.) do not exercise such discipline on a consistent basis. Metadata creation and/or maintenance need time and/or effort. As such, it is impractical to rely on its existence at scale. This is not to minimize the importance of efforts to promote metadata adherence. However, such efforts are complemented with the development of pragmatically designed systems that exploit when available—but do not rely on the existence of such metadata.

It is also useful to distinguish structured metadata (for instance XML fields) from semantic (meaning-oriented) metadata. The former refers to fields such as the name of the author, the date of publication, etc. while the latter refers to ontological-based markup that clearly specifies what a piece of information means. As an illustration, one can have perfectly-formed, validated, structured metadata (e.g., an XML document) that is completely meaningless. Structured metadata (such as RDF and/or RSS) is indeed beneficial especially for queries that rely on structure (e.g., a query to find a specific medical record id, author name, etc.). However, majority of the queries at the level of knowledge are semantic in nature—this is one of the reasons why Google™ has succeeded despite the fact that it does not rely on any structured metadata; to Google™, all web pages are structurally identical (a web page is a web page). Consequently, while standards such as RDF and/or RSS are useful, they still do not address a problem—that of semantic indexing, processing, interpretation, retrieval, filtering, and/or ranking.

The Semantic Web effort appears to place research emphasis on formal, publisher-driven semantic markup. In very narrow, well-controlled domains, semantic markup would have value. However, problems arise at scale. For example, in one of the W3C presentations on the Semantic Web, the following illustration was cited in advocating the benefits of uniquely identifiable semantic tags:

Don't say “color” say “http: //www.pantomine.com/2002/std6#color”

This part of the Semantic Web vision has problems reaching critical mass. Humans don't want to change the way they write. Language has evolved over many thousands of years and/or it is unrealistic to expect that humans may instantly change the way they express themselves (or the effort they put into doing so) for the benefit of intelligent agents. Agents (and/or computers in general) can adapt to humans, not the other way round.

Semantic metadata relies on ontologies, which generally defined, are tools and/or libraries that describe concepts, categories, objects, and/or relationships in a particular domain. The W3C recently approved the Web Ontology Language (OWL) which is a standard for ontology publishers to use to create, maintain, and/or share ontologies (see http: //www.w3c.org/2001/sw/WebOnt/). This is a standard which accelerates the development of ontologies and/or ontology-dependent applications.

However, the development of ontologies presents new challenges. In particular, the expression and/or interpretation of meaning has many philosophical and/or technical challenges. What an item means is usually in the eyes or ears of the beholder. Meaning is closely tied to context and/or perspective. As such, a piece of information can mean multiple things to different people at the same time or to the same person at different times. Differences in opinion, political ideology, research philosophy, affiliation, experience, timing, or background knowledge can influence how people infer or interpret meaning. In research communities, such differences reflect valid differences in perspective and/or are particularly acute in relatively new research areas. For instance, in Theoretical Physics, an ontology on String Theory is an expression of belief by those who believe in the theory in the first place. A body of knowledge in Physics that describes the quest for the Unified Field Theory can be viewed from multiple perspectives, each of which might legitimately reflect different approaches to the problem.

Consequently, it is not completely sufficient to empower a publisher to assert what his or her publication “means.” Rather, others are also able to express their semantic interpretation of what any piece of information “means to them.” Even if humans agreed to replace keywords with URIs (as indicated in the quote above), this still leaves the URIs open to interpretation in different contexts. A URI that is bound to a given context is not completely practical because it presupposes that only the author's perspective matters or is accurate. The basis for contextual interpretation is separated from semantic markup in order to leave open the possibility for multiple perspectives. As such, going back to the quote above, it is fine for “color” to be expressed as “color” (and/or not as a URI) if the interpretation of “color” is realized in concert with one or more semantic annotations of what “color” might mean in a given context. Users are able to dynamically “navigate” across meaning boundaries even if those boundaries are not explicitly connected via semantic markup. From a pragmatic standpoint, this makes the case for more research emphasis on semantic dynamism (code) than on semantic markup (data).

The Problem with Today's Search User Interfaces. Most of today's search user interfaces (such as Google™) comprise of a text box into which users type keywords and/or phrases which are then used to filter results. Other common interfaces expose a directory or taxonomy from which users can then navigate to specific categories. Google™'s user interface is especially popular due to its minimalist design—it has a textbox and/or little else. While simplicity is part of a search user interface, it need not be at the expense of power and/or flexibility. A well-designed intelligent search user interface addresses the following optional features, in accordance with an embodiment of the invention:

1. User Intent: A user interface allows a user to express his or her intent in a way that is as close as possible to what the person has in mind. Search engine users currently have to manually map their intent to keywords and/or phrases, even if those keywords and/or phrases do not accurately reflect their intent. There is as little as possible “semantic mismatch” between the user's intent and/or the process and/or interface used to express that intent. Natural language queries have been touted as the ideal search user interface. Indeed, natural language querying systems have had some success in limited domains such as Help systems in PC applications. However, such systems have been unsuccessful at scale primarily due to the technical difficulty of understanding and/or intelligently processing human language. The challenge therefore is to have a search user interface which is semantic (in that it empowers the user to express intent based on context and/or meaning), yet which does not suffer from the limitations of natural language query technology and/or interfaces. Furthermore, natural language queries require the user to know beforehand what she wants to know. As described herein, this does not reflect how people acquire knowledge in the real-world. A lot of knowledge is acquired based on discovery, serendipity, and/or contextual guidance—it is very common for people not to know what they might want to know until after the fact. As such, a search user interface according to an embodiment blends semantic search and/or discovery so the user is also able to acquire relevant knowledge (based on context) even without asking.

2. Context and/or Semantics: A user interface also allows users to use multiple forms of context to express their intent. It is easy for users to dynamically use context to create semantic queries on the fly and/or to combine different types of context to create new personalized context consistent with the user's task.

3. Time-sensitivity: A user interface also provides time-sensitive alerts and/or notifications that are semantically relevant to the displayed results. Time-sensitivity also is seamlessly integrated with context-sensitivity.

4. Multiple Knowledge and/or Ranking Axes: A user interface also allows the user to issue semantic queries using one or more knowledge axes with different ranking schemes. In addition search results are presented in a way that reflects the context in which the query was issued—so as to guide the user in interpreting the results correctly.

5. Behavior and/or Understanding: A user interface is able to dynamically invoke semantic Web services (or an equivalent) in order to connect displayed items dynamically with remote ontologies for the purpose of “understanding” what it displays in a given context.

6. Semantic Cross-Referencing: A user interface allows the user to cross-reference context across ontologies. For instance, it is possible to use one perspective to view results that were generated via another perspective. Such “cross-fertilization of perspectives” accurately reflects how knowledge is acquired and/or how research evolves in the real-world. Furthermore, a user interface allows the user to cross-reference context in order to dynamically create new semantic views.

7. Personalization—Knowledge Profiles: A user interface allows users to create different knowledge personas based on the task the user is focused on, different work scenarios, different sources of knowledge, and/or possibly, different ontologies and/or semantic boundaries. This is consistent with the connection of knowledge to purpose, as described herein.

8. Personalization—Flexible Presentation: A user interface allows users to be able to customize how results get presented. Users are able to customize the visual style, fonts, colors, themes, and/or other presentation elements.

9. Personalization—Attention Profiles: A user interface allows users to configure their attention profiles. These would be employed for alerts and/or other notifications in the user interface. These are not unlike profiles in mobile phones that specify whether a user can be disturbed or not, and/or if so, how—e.g., Normal, Silent, Meeting, etc.

10. Federation—Knowledge Source Federation: A user interface allows the user to issue semantic queries and/or retrieve relevant results from diverse knowledge indexes and/or have those results presented in a synthesized manner—as though they came from one place. This allows the user to focus on his or her task without having to perform multiple queries (to different sources) each time.

11. Federation—Semantic Federation: A user interface allows the user to issue semantic queries to diverse knowledge indexes even if those indexes cross semantic (or ontology) boundaries. A user interface allows the user to hide semantic differences during the query process (if she so wishes for the task at hand)—the user is able to configure the knowledge indexes and/or issue queries without having to know that context-switching is dynamically occurring in the background while queries are being processed.

12. Federation—Security Federation: A user interface allows the user to seamlessly issue semantic queries and/or retrieve relevant results across security silos even if she uses different security credentials to access these silos.

13. Awareness: A user interface allows the user to keep track of context and/or time-sensitive information across multiple knowledge sources simultaneously.

14. Attention-Management: A user interface may only be disrupted or interrupted when absolutely necessary based on the user's current task and/or the user's attention profile. This is similar to what an efficient human assistant or research librarian would do.

15. Dynamic Follow-up and/or Drill-down: A user interface allows the user to dynamically follow-up on results that get retrieved by issuing new queries that are semantically relevant to those results or by drilling down on the results to get more insights. This is similar to what typically happens in the real-world: the retrieval of results by an efficient research librarian is not the end of the process; rather, it usually marks the beginning of a process which then involves intellectual exchange and/or follow-up so the user can dig into the results to gain additional perspective. The acquisition of knowledge is a never-ending, recursive process.

16. Time-Management—Summaries, Previews, and/or Hints: A user interface also proactively saves the user's time to providing summaries, previews, and/or hints. For instance, a user interface allows a user to determine whether she wants to view a result or navigate a new contextual axis before the commitment to navigate actually gets made. This enhances browsing productivity.

17. Discoverability of new Knowledge Sources: A user interface allows the user to dynamically discover new knowledge sources (with semantic indexes) as they come online.

18. Seamless integration with user context and/or workflow: A user interface is seamlessly integrated with the user's context and/or workflow. The user is able to easily “flow” between his or her context and/or the user interface.

19. Knowledge Capture and/or Sharing: A user interface enables the user to easily share knowledge with his or her communities of knowledge. This includes easy knowledge publishing that encourages users to share knowledge and/or annotations so users can provide opinions and/or commentary on results that get displayed in the user interface.

20. Context Sharing and/or Collaboration: A user interface allows users to be able to easily share dynamic context and/or queries.

21. Ease of Use and/or Feature Discoverability: A user interface is easy to use. It provides power and/or flexibility and/or should support the optional features listed above but it does so in a way that is easy to learn and/or use. Also, the features supported in a user interface are easy for users to find and/or manage, and/or are exposed in a way that is contextually relevant to the user's task but without overwhelming the user.

Semantic Indexing. In order to support intelligent retrieval, an embodiment of the invention uses a model for integrating semantics into an information index. Such a semantic index meets the following optional features, in accordance with an embodiment of the invention:

1. Multiple schemas: the index allows multiple well-known object types with different schemas (e.g., documents, events, people, email messages, etc.) to co-exist in a consistent data model. However, the index does not depend on the existence of rich metadata; the index may allow for cases where the schema is sparsely populated (except for core fields such as the source of the data) due to the absence of published metadata.

2. Flexible knowledge representation: the index allows for the flexible representation of knowledge. This representation allows for a rich set of semantic links to describe how objects in the index relate to one another.

3. Seamless domain-specific and/or domain-independent knowledge representation: the semantic index also allows for semantic links that refer to category objects that are domain and/or ontology specific. However, the index has a consistent data model that also includes domain-independent semantic links. For example, the semantic link described with a predicate “is category of” is domain and/or ontology-dependent whereas a semantic link described with a predicate “reports to” or “authored” is domain-independent. Such semantic links co-exist to allow for rich semantic queries that cut across both classes of predicates.

4. Multiple perspectives: seamless semantic federation and/or ontology co-existence: As described herein, a semantic system supports multiple viewpoints of the same information in order to capture the polymorphism of interpretation that exists in the real world. As such, a semantic index allows semantic links to co-exist in the same data model across diverse ontologies. Furthermore, the semantic index is able to be federated with other semantic indexes in order to create a virtual network of meaning that crosses boundaries of perspective (or semantic silos). Support for semantic federation also implies that the semantic index is complemented with an intelligent semantic query processor that can dynamically map context to the semantic index in order to retrieve results from the semantic index according to the ontologies represented in the index. These results can then be federated with results from other semantic indexes to create a consistent yet virtual query model that crosses semantic boundaries.

5. Inference: the index also supports inference engines that can “observe” the evolution of the index and/or infer new semantic links accordingly. For example, semantic links that relate to document authorship can be interpreted along with semantic links that define how documents relate to categories (of one or more ontologies) to infer topical expertise. The semantic index allows an inference engine to be able to mine and/or create semantic links.

6. Maintenance: The semantic index is maintainable. Semantic links are easily updatable and/or dead links are removed without affecting the integrity of the entire index.

7. Performance and/or Scalability: The semantic index interprets and/or responds to real-time, dynamic semantic queries. As such, the index is carefully designed and/or tuned to be very responsive and/or to be very scaleable. Indexing speed, query response speed, and/or maximum scalability (via scale-up and/or scale-out) are on the same order of magnitude as the performance and/or scalability of today's search engines.

7.1 Dynamic Semantic Indexing in the Information Nervous System. Semantic indexing in an embodiment of the invention is accomplished with two components: one that handles the dynamic processing of semantics (called the Knowledge Domain Service (KDS) ) and/or another that integrates meaning into a semantic index (called the Knowledge Integration Service (KIS)).

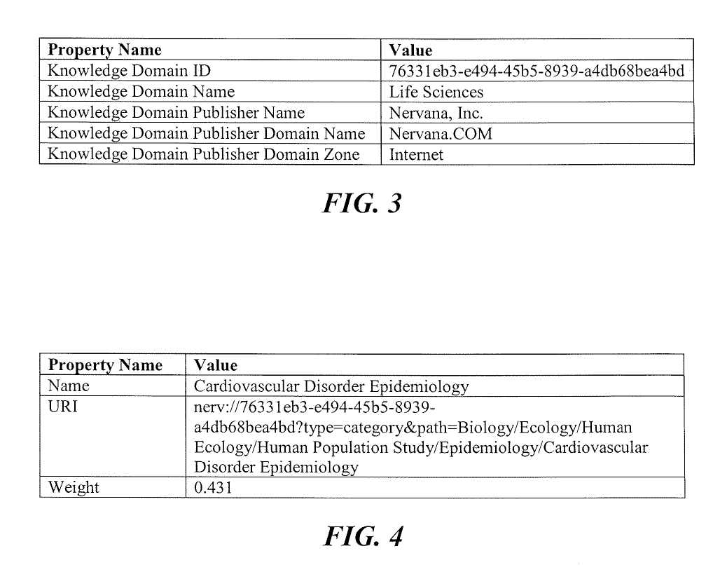

7.1.1 The Knowledge Domain Service. The Knowledge Domain Service (KDS) hosts one or more ontologies belonging to one or more knowledge domains (e.g., Life Sciences, Information Technology, Aerospace, etc.). The KDS exposes its services via an XML Web Service interface. The primary methods on this interface allow clients to enumerate the ontologies installed on the KDS and/or to retrieve semantic metadata describing what a document, text blob, or list of concepts (passed in as input) “means” according to a given ontology on the KDS. The KDS Web service returns its results via XML. FIG. 3 shows an example of metadata fields that the KDS returns when “asked” to enumerate its installed ontologies, in accordance with an embodiment of the invention. The Knowledge Domain ID uniquely identifies the ontology. The Knowledge Domain Name is a friendly name that describes the knowledge domain. The Knowledge Domain Publisher Name is the name of the ontology publisher. The Knowledge Domain Publisher Domain Name identifies the publisher on the Internet, Intranet, or Extranet. The Knowledge Domain Publisher Zone indicates the scope of the domain name (Internet, Intranet, or Extranet). This model allows for both public and/or private ontologies to share the same ontology namespace.

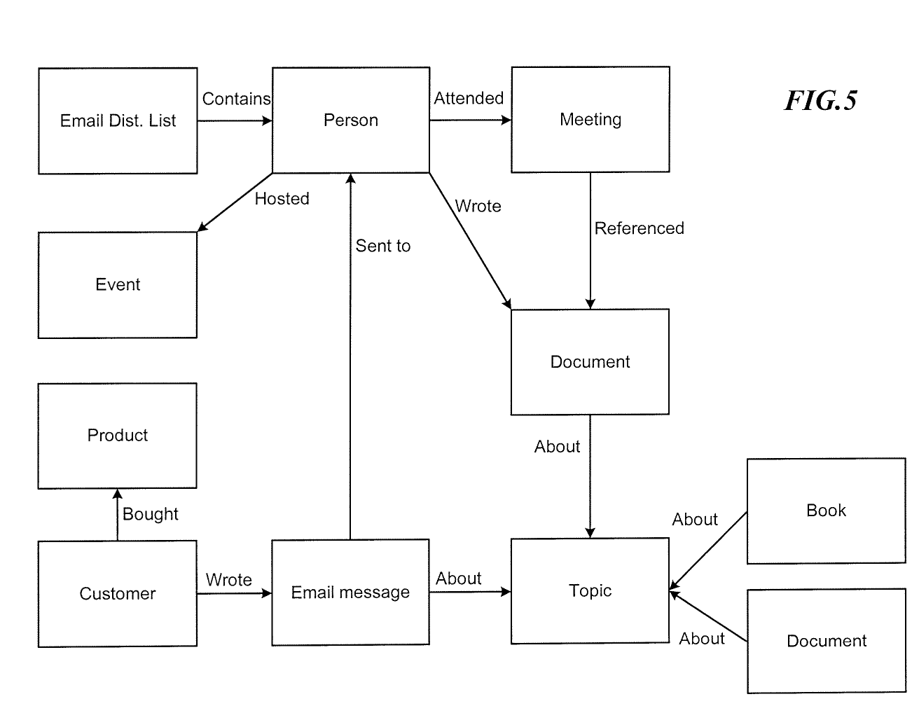

When asked to categorize an information item according to an ontology, the KDS Web service may return XML that describes a list of mappings—nodes in the ontology and/or weights that describe the semantic density of the input item per node. For instance, in a typical scenario, a client of the KDS Web service would pass in a Url to a Web page (in the Life Sciences knowledge domain) and/or also pass in a unique identifier that refers to the ontology that the client wants the KDS to use to interpret the input (presumably an ontology in the Life Sciences domain). FIG. 4 illustrates the schema and/or sample fields of a KDS result, in accordance with an embodiment of the invention.

This result describes the name of the node in the taxonomy/ontology (“Cardiovascular Disorder Epidemiology”), a Uniform Resource Identifier (URI) that uniquely identifies the node in the ontology, and/or a weight that captures the frequency of incidence of concepts in the input item measured against the concepts in the ontology around the returned node. The inclusion of the knowledge domain identifier (which identifies the ontology) and/or the full-path of the node within that ontology ensure that the returned URI is unique from a semantic standpoint. New ontologies are assigned new unique identifiers in order to distinguish them from existing ontologies.

7.1.2 The Knowledge Integration Service (KIS), in accordance with an embodiment of the invention, crawls and/or semantically integrates disparate sources of information (such as Web sites, file shares, Email stores, databases, etc.). The crawling functionality can be separated out into another service for scalability and/or load balancing purposes. The KIS may have an administration interface that allows the administrator to create one or more knowledge bases. The knowledge base may be called a “Knowledge Community” because it includes not only semantic information but also People. For a given knowledge community (KC), the administrator can set up information sources to be indexed for that KC. In addition, the administrator can configure the KC with one or more knowledge domains, including the Url to the KDS Web service and/or the unique identifier of the ontology to be used to create the semantic index. The KC can allow the administrator to use multiple ontologies in indexing the same set of information sources—this allows for multiple perspectives to be integrated into the semantic index.

As the KIS crawls information sources for a given KC (e.g., Web sites), it can pass the Url of the crawled information item to each of the KDS Web services it has been configured with for that KC. This is akin to the KIS “asking” each KDS what the item “means to it.” Note that there is still no universal notion of what the item means. The item could mean different things to different KDSes and/or ontologies. Because the XML returned by each KDS can uniquely identify the ontology entry, the KIS now has enough information with which to annotate the information item with meaning, while preserving the flexibility of multiple and/or potentially diverse semantic interpretations.

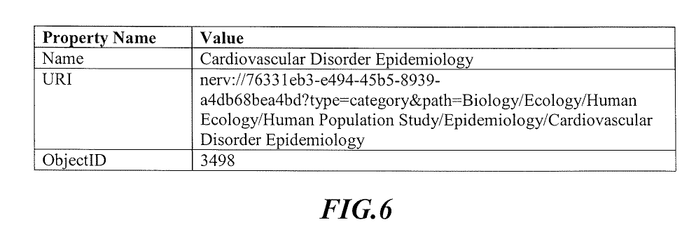

The KIS can store its data using a semantic network. The network may be represented via triples that have subject nodes, predicates, and/or object nodes and/or stored in a relational database. The semantic network can include objects of various semantic types (such as documents, email messages, people, email distribution lists, events, customers, products, categories, etc.). As the KIS crawls objects (e.g., documents), the objects may be added to the semantic network as subjects and/or predicates are assigned and/or linked to the network dynamically as each object gets semantically processed and/or indexed. Examples of predicates include “belongs to category” (linking a document with a category), “includes concept” (linking a document with a concept or keyword), “reports to” (linking a person with a person), etc. The subject entries in the semantic network also include rich metadata, if such metadata is available. This provides the KIS with a rich index of both structured metadata (if available) and/or semantic metadata from multiple perspectives. However, the latter does not rely on the former—the KIS is able to build a semantic network with semantic metadata even if the subjects in the network do not have structured metadata (e.g., legacy Web pages). The implication of this is that with the KIS and/or KDS, an embodiment of the invention can provide a semantic user experience even without semantic markup or a Semantic Web. FIG. 5 illustrates the representation of a semantic network in the KIS, in accordance with an embodiment of the invention. As the KIS retrieves category information back from each KDS it may be configured with, it can add new categories into the semantic network if those categories do not exist already.

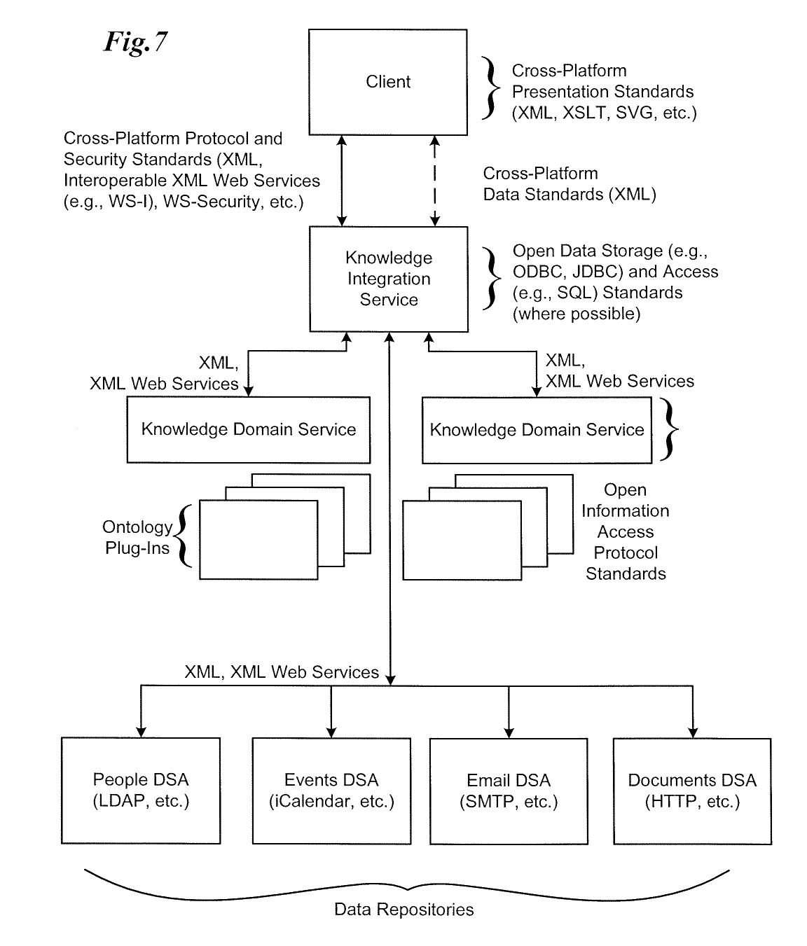

FIG. 6 illustrates the schema and/or sample fields of a category that gets added to the semantic network, in accordance with an embodiment of the invention. The Name and/or URI fields are consistent with the schema of what gets returned by the KDS.

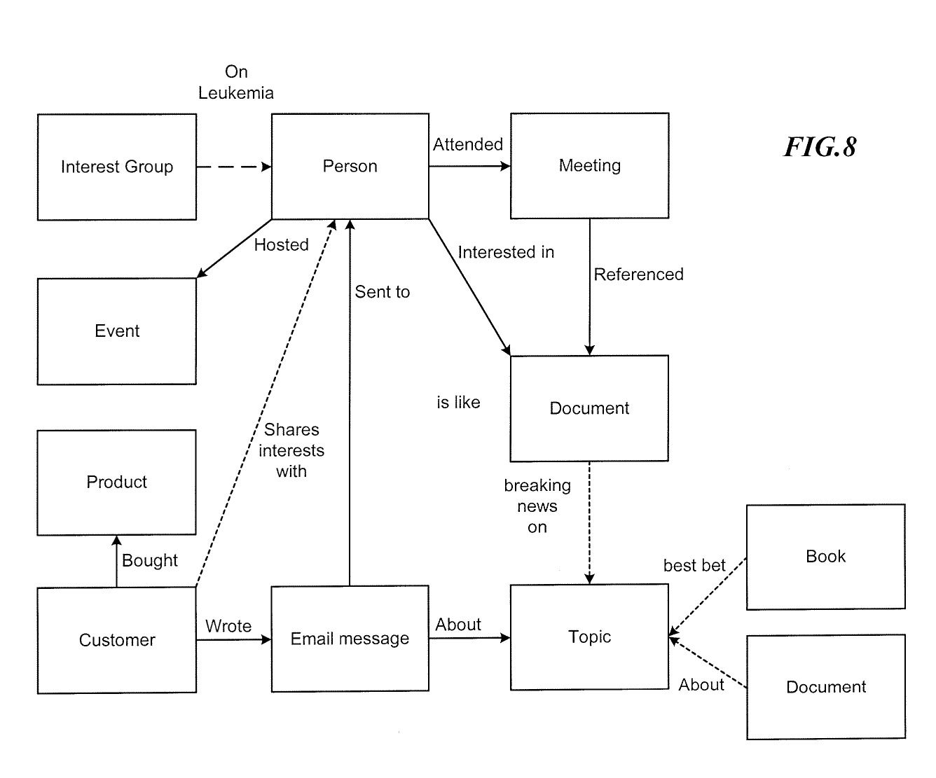

FIG. 7 illustrates the separation of the KIS and/or KDS for the purposes of supporting multiple perspectives, and/or also how they work together to build the semantic index which is managed by the KIS, in accordance with an embodiment of the invention. FIG. 7 also shows the client (the semantic browser) and/or how it interacts with the KIS to issue semantic queries and/or retrieve results. An embodiment of the invention is able to access and/or index content from diverse repositories. Many enterprises have standard and/or custom repositories that run on multiple platforms. An embodiment of the invention is able to access all these repositories. The KIS has been designed to natively support file shares, Web sites, RSS and/or OPML. Additional native connectors include email (for the System Inbox, which may be used for publications and/or annotations) and/or LDAP directories (for People). Custom repositories are supported via a standard architecture involving RSS over HTTP. This keeps the KIS architecture clean and/or stable and/or abstract out schema and/or platform differences at the connector level. Connector. Each connector may be a standalone product that “speaks” RSS over HTTP. The KIS can then index the generated RSS feed similar to any “standard” RSS feed. On Windows, connectors may be implemented as ASP.NET applications. This provides HTTP accessibility. Each connector can support the following: 1. Multiple Endpoints: Each connector may be configured with one or more endpoints specific to the application in question. For instance, an email connector may be able to be configured with multiple inboxes that are abstracted via RSS. Each connector can define its own endpoint and/or store configuration state as needed. Each endpoint is able to live on its own servers (endpoints can be federated). 2. RSS Feed Web Folders: Each connector can allow the administrator to configure an RSS feed web folder per endpoint or an RSS web folder for all endpoints. The administrator might want an RSS feed (and/or web folder) per endpoint or might want to have an aggregate feed that encapsulates all endpoints. Both options are allowed. 3. Automatic Updates: Each connector can automatically “crawl” its endpoints and/or generate up-to-date RSS feeds that represent these endpoints. The connector can allow the administrator to configure the crawl frequency per endpoint or for the entire application. 4. RSS Version: Each connector can generate RSS version 2.0. 5. HTTP Addressability: Each connector can generate a URL that abstracts an information item, based on the application in question. For instance, a document in a content management system has an HTTP URL that the connector ASP.NET (or equivalent) application processes to return the contents of the document. This is a “cross-application redirect.” The connector is responsible for passing HTTP GET requests across application boundaries in order to retrieve the information item(s). 6. RSS Item Caching: Optionally, each connector could cache the generated list of RSS items in a local database installed with the product (e.g., SQL Server Express). This cache would allow sophisticated filtering and/or queries in order to retrieve “sub-feeds” based on queries the administrator defines. 7. Search Queries: Optionally, each connector could accept arguments to its RSS feed HTTP URL endpoint that represents search arguments. The connector could then return a “sub-feed” that corresponds to the search. 8. Required HTTP Headers: Each connector, in an embodiment, can return the following headers in response to the HTTP “HEAD” request: CONTENT-LENGTH: This returns the size of the information item. CONTENT-TYPE: This returns the MIME type of the information item. LAST-MODIFIED: This returns the last modified date-time of the information item. CONTENT-LANGUAGE: This returns the language in which the information item is encoded. 9. Authentication Information: Each connector can allow the administrator to provide authentication information for each endpoint. The connector can perform the authentication needed to access each endpoint, using the authentication information provided by the administrator. 1O. Configuration User Interface: Each connector can provide a user interface (via a Web admin or Windows forms or an equivalent) to allow the administrator to: Add/remove endpoints (including authentication information) and/or corresponding RSS feeds and/or Schedule crawls. Connector Components. The connector components include a set of base components and/or custom components that can be connector-specific. The base components are implemented so that their interfaces and/or methods can be overridden as needed by individual connectors. The Base Component set includes, in an embodiment: 1. Endpoint (ILEndpoint): this component abstracts out the details of a specific endpoint. The data representation is a URI, which is a virtual identifier that represents the endpoint. Each endpoint also has optional authentication information, a username and/or password. Each connector has its own implementation of an endpoint, with code to interpret the URI. Each endpoint object is responsible for crawling itself. This is not unlike how the Directory object in .NET is responsible for enumerating its files. In this context, the component is responsible for connecting to an endpoint, retrieving data from the endpoint and/or mapping the data to Endpointltem objects. This is not unlike how the Directory object in .NET returns FileInfo objects. Objects implementing the IEndpoint interface may optionally be able to page through the data they enumerate, and/or optionally take search parameters to restrict the result set. 2. Endpoint Manager: this component manages the storing and/or retrieval of endpoint configuration settings, including the secure storage of authentication information as needed. The Endpoint Manager deals with abstract Endpoint objects. 3. Endpointltem: this component abstracts out an Endpoint item. An EndpointItem includes connector-specific endpoint information that identifies the item to be retrieved. An EndpointItem object is also responsible for fetching the data for the object it represents. Each EndpointItem is also able to convert its data representation to RSS. 4. RSS Generator: this component generates the master RSS feed for an endpoint. The component does not know how the RSS is generated—this is the responsibility of the connector. The RSS is fed into the generator via EndpointItem objects. The RSS Generator component is also able to chop this feed into multiple RSS files and/or generate a master OPML feed that refers to the RSS feeds. The generator is able to persist the RSS feed(s) to configured Web folders for remote access, via local file copy or FTP. 5. EndpointScheduler: this component stores and/or retrieves configuration settings for scheduling endpoint crawls. The component is also responsible for invoking and/or stopping crawls based on configured schedules. 6. EndpointItemCache: this component manages the storage of cached RSS Items—to a local store (e.g. a SQL store). 7. EndpointConnector: this is the component that is exposed to callers, primarily the ASP.NET application. Initially, this is a managed interface (e.g., a .NET assembly). This component exposes all the methods needed for abstracting an RSS feed, and/or returning data for an RSS item, given a set of arguments. These arguments are fed to the component by the ASP.NET application in response to an HTTP request. The RSS is returned to the component either in a memory buffer or via a Web folder path, if the entire RSS feed for an endpoint is requested. 8. ASP.NET Application: this is the ASP.NET application that maps HTTP requests (“HEAD” and/or “GET”) to and/or from the RSSConnector component. The following disclosure is in accordance with an embodiment of the invention. Parts of the invention may be practiced alone or in combination with one or more other parts of the invention.

Client Assistance in Duplicate Management. Co-pending application (U.S. patent application Ser. No. 11/127,021 filed May 10, 2005) outlines a system whereby a client (semantic browser) can assist in purging a server(s) of stale items (items that have been deleted). In an embodiment, a similar model can be employed for duplicate management. In this case, if a user notices a duplicate, he/she can invoke a verb in the semantic browser which may then invoke a Web service call on the KIS (agency) to remove the duplicate. This way, the burden of duplicate-detection (which is a non-trivial problem) is shared between the server, the client, and/or the user.

Server Data and/or Index Model.

Documents Table Data and/or Index Model

| Column Name | Data Type | Indexed | Comments |
|---|---|---|---|
| ObjectID | BIGINT | Yes | |
| | (8 bytes) | (primary key; | |
| | | clustered) | |
| ObjectTypeID | INT (4 bytes) | Yes (non- | |
| | | clustered) | |
| Title | UNICODE | No | |
| | String | | |
| Summary | UNICODE | No | |
| | String | | |
| SourceUri | UNICODE | Yes (non- | UNIQUE constraint |
| | String | clustered) | |
| Language | UNICODE | No | |
| | String | | |
| OriginalCreationTime | DATETIME | No | |
| OriginalLastModifiedTime | DATETIME | No | |
| ObjectCreationTime | DATETIME | Yes (non- | |
| | | clustered) | |
| ObjectLastModifiedTime | DATETIME | No | |
| Size | BIGINT | No | |
| BetStrength | BIGINT | No | Indicates the aggregate |
| | | | semantic strength of the |
| | | | document |
| NumConcepts | BIGINT | No | Indicates the number of |
| | | | concepts in the |
| | | | document |
| Creators | UNICODE | No | |
| | String | | |
| Contributors | UNICODE | No | |
| | String | | |
| Publishers | UNICODE | No | |
| | String | | |
| BestBetHint | SMALLINT | Yes (non- | Indicates whether this is |
| | (2 bytes) | clustered) | a the Best Bet. This is |
| | | | updated by the |
| | | | Semantic Inference |
| | | | Engine (SIE). |
| RecommendationHint | SMALLINT | Yes (non- | Indicates whether this is |
| | (2 bytes) | clustered) | a Recommendation. |
| | | | This is updated by the |
| | | | Semantic Inference |
| | | | Engine (default value is |
| | | | 2/3 the Best Bet |
| | | | semantic strength). |
| BreakingNewsHint | SMALLINT | Yes (non- | Indicates whether this is |
| | (2 bytes | clustered) | Breaking News. This is |
| | | | updated by the Time- |
| | | | Sensitivity Inference |
| | | | Engine. Currently, this |
| | | | is implemented based |
| | | | on the intersection of |
| | | | the specified Breaking |
| | | | News time threshold |
| | | | and/or the |
| | | | Recommendations |
| | | | semantic strength |
| HeadlinesHint | SMALLINT | Yes (non- | Indicates whether this is |
| | (2 bytes) | clustered) | Breaking News. This is |
| | | | updated by the Time- |
| | | | Sensitivity Inference |
| | | | Engine. Currently, this |
| | | | is implemented based |
| | | | on the intersection of |
| | | | the specified Headlines |
| | | | time threshold and/or |
| | | | the Recommendations |
| | | | semantic strength |
| BetRankHint | SMALLINT | Yes (non- | This is a representative |
| | (2 bytes) | clustered) | score of the semantic |
| | | | strength from 0-10 |
| RichMetadataHint | SMALLINT | No | This indicates whether |
| | (2 bytes) | | the document came |
| | | | from a rich metadata |
| | | | source (like RSS) |
| SemanticHash | UNICODE | No | This is a hash of the |
| | String | | body of the documents; |
| | | | used for duplicate |
| | | | detection. Currently, this |
| | | | is implemented by |
| | | | appending the concepts |
| | | | (key phrases) of the |
| | | | document in |
| | | | alphabetical order |

Objects Table Data and/or Index Model.

Objects Table Data and/or Index Model

| | | | |
|---|---|---|---|
| Column Name | Data Type | Indexed | Comments |

| | | |
|---|---|---|
| ObjectID | BIGINT | Yes |
| | (8 bytes) | (primary key; |
| | | clustered) |
| ObjectTypeID | INT (4 bytes) | No |
| Uri | UNICODE | Yes |
| | String | (non-clustered) |

Semantic Links Table Data and/opr Index Model

Semantic Links Table Data and/or Index Model

| Column Name | Data Type | Indexed | Comments |
|---|---|---|---|
| LinkID | BIGINT | Yes | |
| | (8 bytes) | (non- | |
| | | clustered) | |
| SubjectID | BIGINT | Yes | |
| | (8 bytes) | (non- | |
| | | clustered) | |
| PredicateTypeID | INT | Yes | |
| | (4 bytes) | (non- | |
| | | clustered) | |
| ObjectID | BIGINT | Yes | |
| | (8 bytes) | (non- | |
| | | clustered) | |
| LinkStrength | BIGINT | Yes | |
| | (8 bytes) | (non- | |
| | | clustered) | |
| BestBetHint | SMALLINT | Yes | Represents the Best |
| | (2 bytes) | (non- | Bet context |
| | | clustered) | predicate. This is |
| | | | updated by the |
| | | | Semantic Inference |
| | | | Engine. |
| RecommendationHint | SMALLINT | Yes | Represents the |
| | (2 bytes) | (non- | Recommendations |
| | | clustered) | context predicate. |
| | | | This is updated by |
| | | | the Semantic |
| | | | Inference Engine |
| | | | (default value is 2/3 |
| | | | the Best Bet |
| | | | semantic strength). |
| BreakingNewsHint | SMALLINT | Yes | Represents the |
| | (2 bytes) | (non- | Breaking News |
| | | clustered) | context predicate. |
| | | | This is updated by |
| | | | the Time-Sensitivity |
| | | | Inference Engine. |
| | | | Currently, this is |
| | | | implemented based |
| | | | on the intersection |
| | | | of the specified |
| | | | Breaking News time |
| | | | threshold and/or the |
| | | | Recommendations |
| | | | semantic strength |
| HeadlinesHint | SMALLINT | Yes | Represents the |
| | (2 bytes) | (non- | Headlines context |
| | | clustered) | predicate. This is |
| | | | updated by the |
| | | | Time-Sensitivity |
| | | | Inference Engine. |
| | | | Currently, this is |
| | | | implemented based |
| | | | on the intersection |
| | | | of the specified |
| | | | Headlines time |
| | | | threshold and/or the |
| | | | Recommendations |
| | | | semantic strength |
| BetRankHint | SMALLINT | Yes | This is a |
| | (2 bytes) | (non- | representative score |
| | | clustered) | of the semantic |
| | | | strength of the link, |
| | | | from 0-10 |

There may be a composite index which is the primary key (thereby making it clustered, thereby facilitating fast joins off the SemanticLinks table since the database query processor may be able the fetch the semantic link rows without requiring a bookmark lookup) and/or which may include the following columns: SubjectID; PredicateTypeID; ObjectID; BestBetHint; RecommendationHint; BreakingNewsHint; HeadlinesHint; BetRankHint.

Fast Incremental Meta-Indexing. Fast Incremental Meta-Indexing (FIM) refers to a feature of the Knowledge Integration Service (KIS) of an embodiment of the invention. This feature can apply to the case where the KIS indexes RSS (or other meta) feeds. On an incremental index, the KIS can check each item to see whether it has already indexed the item. In the case of a feeds like RSS feeds, the “item” (e.g., a URL to an RSS feed) contains the individual items to be indexed. In this case, the KIS keeps track of which RSS items it has indexed via a MetaLinks table in the Semantic Metadata Store (SMS). On an incremental index, the KIS checks this table to see if the meta-link (e.g. an RSS URL) has been indexed. If it has, the KIS skips the entire meta-link. This makes incremental indexing of meta-links (like RSS feeds) very fast because the KIS doesn't need to check each individual item referred by the link.

Adaptive Ranking. The Knowledge Integration Service (KIS) in an embodiment of the invention assigns Best Bets based on the semantic strength of a semantic object (e.g., a document) in a given context (e.g., a category), based on the categorization results of the Knowledge Domain Service (KDS) in one or more knowledge domains. By default, in one embodiment, the Best Bets semantic threshold is 90%. However, “Best Bets” refers to the best documents on a RELATIVE score, not an absolute score. As such, the semantic threshold may be adjusted based on the semantic density of the documents in the index (in a given Knowledge Community (KC)). The KIS can implement this via its Semantic Inference Engine (SIE). This Inference Engine can run on a constant basis (via a timer) and/or for each running knowledge community installed on the server, track the maximum semantic strength for all the documents that have been added to the index. The SIE then can update the BestBetHint based on the maximum semantic strength in the index. This update may be done in BOTH the documents table and/or the semantic links table (ensuring that the context-sensitive semantic links are also updated). This ensures that “Best Bets” are based on the relative semantic density in the index. For instance, when indexing abstracts (like Medline abstracts), Best Bets become “Best Abstracts,” since the semantic density distribution is very different for abstracts (since there is much lower data density). Also, the semantic threshold for Recommendations (and/or Breaking News and/or Headlines) can then be adjusted based on the Best Bets threshold. In one embodiment, the Recommendations threshold is two-thirds of the Best Bets threshold. If the Best Bets threshold changes, the Recommendations threshold is also be changed. Similarly, in one embodiment, Breaking News and/or Headlines are set to time-sensitive filters layered on top of Recommendations. The SIE also then invokes the Time-Sensitivity Inference Engine (TSIE) to update Breaking News and/or Headlines accordingly. The implication of all this is that while the index is running, a document could be dynamically added as Best Bets, Breaking News, or Headlines, as the semantic density distribution changes.

Smart Adaptive Ranking. In one embodiment, the SIE's Adaptive Ranking algorithm can go further than merely adjusting the semantic hints (BestBetHint, etc.) based on the semantic threshold. The SIE also keeps track of the number of Best Bets, Recommendations, etc. It does this because in some cases, the semantic density distribution could be overly skewed in one direction. For instance, one could have a distribution with very few Best Bets, and/or few Recommendations. This is undesirable because it also would affect Breaking News and/or Headlines (too few time-sensitive results, filtered out based on semantic density) and/or may reduce the effectiveness of context-sensitive ranking. The SIE can address this by having a minimum percentage of Best Bets that is in the index. By default, this may be 1%. Before updating the BestBetHint based on the semantic threshold, the SIE checks for the number of documents above the current “high-water” semantic threshold mark. If the percentage of this value (relative to the total number of documents in the index) is less than 1%, the SIE reduces the Best Bets threshold by 1. The SIE then invokes this algorithm again (periodically, since it can run on a timer) and/or continues to adjust the Best Bets threshold until the ratio of Best Bets to All Bets is more than 1%. This guarantees that the semantic distribution remains “reasonably normal” and/or does not start to assume log-normal like characteristics. Furthermore, in one embodiment, Smart Adaptive Ranking is be implemented on a context-sensitive basis. In this case, the algorithm is applied WITHIN the semantic network for EACH category object that each knowledge subject refers to via a semantic link. This would ensure, for instance, that Best Bets on Cardiovascular Disease would truly be the best bets IN THAT CONTEXT, based on the semantic rank threshold FOR THAT CONTEXT. The SIE can implement this by invoking the aforementioned rule for each category by traversing each semantic link in the semantic network.

Notes on Adaptive Ranking. In an embodiment, the implication of Adaptive Ranking is that Best Bets are now actually Best Bets and/or not Great Bets (as was the case previously); there may always be Best Bets. A document can stop being a Best Bet—if the index changes, what was previously “Best” might become “Average” or “OK.” A document can stop being a Recommendation in a manner similar to that described above. A document can suddenly stop being Breaking News, if it no longer constitutes News (if its rank is now poor, relative to the distribution). This is akin to CNN Headline News where some “Headlines” can stop being Headlines across 30-minute boundaries (due to a new prevalence of much more important “News”). Or where “Headlines” can get “bumped” from the queue due to late-breaking news (which might be slightly older—but too longer to report—but more important). This change is not critical when all documents have a large (full-text) semantic density—with a consistent semantic distribution (Great Bets tended to be Best Bets). However, with abstracts (as is the case with Medline), this assumption doesn't hold. This change now means that Best Bets, Recommendations, Breaking News, and/or Headlines are much more reliable and/or accurate. The Adaptive Ranking may only cause these jumps while the semantic distribution is unstable. Once the distribution stabilizes, Best Bets may remain “Best.” And/or so on . . . So these illustrations may be most apparent EARLY in the indexing cycle—before the semantic distribution matures.

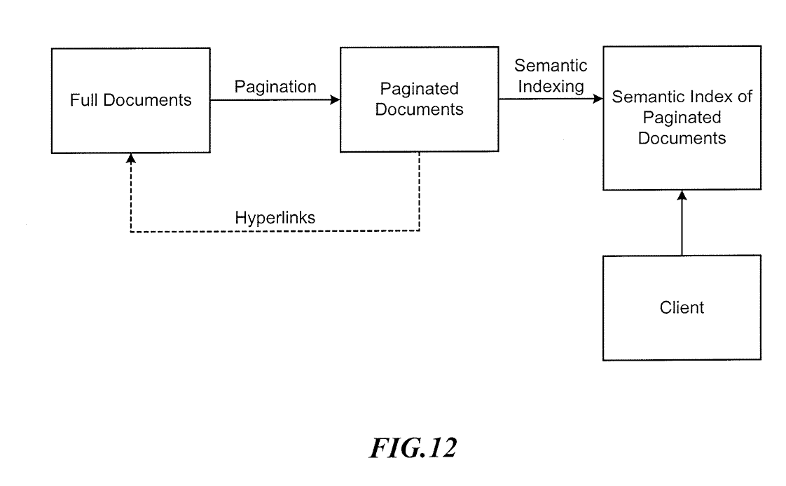

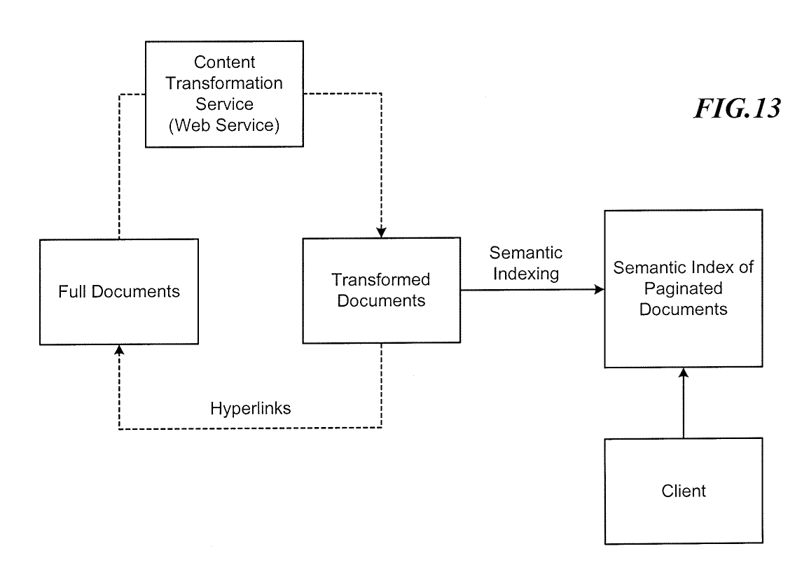

Pagination and/or Content Transformation. Many documents that knowledge-workers search for are lengthy in nature and/or occasionally could cover a lot of different topics. If the complete documents are indexed by the Knowledge Integration Server (KIS), the end-user may get results at the client corresponding to the full documents. For very long documents, this could be frustrating because only specific sections of the documents could be semantically relevant in the context of the user's request. To address this, an embodiment of the invention has a feature wherein the documents get paginated before they are semantically indexed. The pagination may be done in a staging process upstream of the indexing process. Each paginated document then may have a hyperlink to the original document. When the user views the paginated document, the user can then navigate to the original document. This model ensures that if only specific pages within a long document are semantically relevant, only those pages may get returned and/or the user may see the specific pages in the right context (e.g., Best Bets). Furthermore, with Adaptive Ranking and/or Smart Adaptive Ranking in place, there may not be any loss in relative precision or recall when indexing pages rather than full documents, due to the relativistic nature of the ranking algorithm. In another embodiment, other types of document subsets (and/or not only pages) can be indexed. For instance, chapters, sections, etc. can also be indexed using the same technique described above. See, for example, the Pagination Pipeline Architecture Diagram in FIG. 12. In one embodiment, this model is extended to cover other types of “content transformations.” Examples include optical-character-recognition (for image-to-text conversion), language translation, and/or content-cleansing (e.g., removing ads from web pages). In this model, the second stage in FIG. 12 is replaced with a generic “content transformation” stage as shown in FIG. 13. In one embodiment, this is represented by a Content Transformation Service (CTS), implemented as a Web Service. As the KIS crawls information items using the Data Source Adapters (DSAs), it can be configured to first transform the content via one or more CTSes. In this scenario, the CTS acts as a KDS except that its function is to transform content rather then categorize content. CTSes can also be chained together such that one CTS can call another CTS to perform another layer of transformation (and/or so on). In one embodiment, KIS support for the content transformation pipeline may be handled via RSS. For each RSS item, the output (transformed) RSS file may have a Nervana namespace-qualified tag (linkToBeIndexed). If this element has an entry, the KIS can index this link (the user may still see the original link). Else the KIS can index the original link. See, for example, FIG. 13.

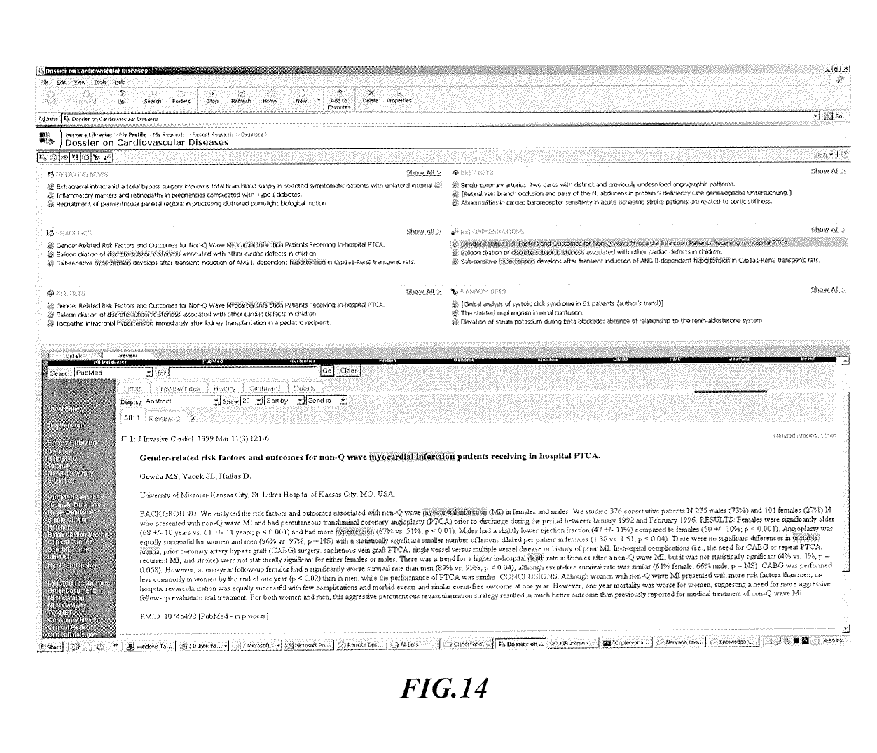

Semantic Highlighting is a feature of an embodiment of the invention that allows users to view the semantically relevant terms when they get results from a semantic query using the semantic client. This is much more powerful than today's regular keyword highlighting systems because with semantic highlighting, the user may be able to see why a result was semantically chosen by viewing the keywords, based on the context of the semantic query. The first part of the implementation has to do with the fetching of the terms to be highlighted for a given query. This can be implemented on the client or on the server. Doing it on the client has the advantage of user scalability since the local CPU power of the client can be exploited (on the other hand, the server would have to do this for each client that accesses it). However, doing this on the server has the advantage of ontology scalability because servers typically would have more CPU and/or memory resources to be able to navigate large ontology graphs in order to fetch the highlight candidate terms. The following steps describe the implementation of one embodiment (with occasionally references to the alternative (server-side) embodiment): 1. The client semantic runtime may lazily cache an ontology graph for each ontology in each KC it subscribes to. In one embodiment, this graph may be handled via the XPath Navigator (e.g., the XPathNavigator object in the .NET Common Language Runtime (CLR)—the navigator object itself gets cached (for large graphs, this could take a while to load and/or caching it may make highlighting performance quick). Alternatively, this could be manually represented as a set of hash tables for quick, constant-time (0(1)) lookup. These hash tables may then point to hash tables (one set of hooks and/or another for exclusions) which would include the ontology terms. The graph may be pre-persisted to disk but may only be cached to memory lazily to minimize memory usage. In an alternative embodiment, the server may do the same. The server may cache one ontology graph across all its KCs—since there might be different KCs that have the same ontologies. 2. The client semantic runtime may download all the ontologies from the KC the user is subscribed to. It does this so as to be able to cache the graphs locally. To download the ontologies, the client asks the KC for the ontology GUIDs it is configured with as well as the KDS server names that host the ontologies. In one embodiment, the client then downloads the ontologies via HTTP by invoking a dynamically constructed URL (like http://kds.nervana.com nervkdsont/<guid>/ontology.ont.xml). “NervKDSOnt” is a virtual folder installed with the KDS and/or which points to the root of the ontology folder (containing the ontology plug-ins installed on the KDS). 3. For virtual KCs (where the KC is a redirector to standard or “real” KCs—for federation purposes), the client might not have direct access to the KDSes that the KIS that hosts the KC refers to. For instance, an Internet-facing KC might federate many local KCs within a private workgroup that isn't accessible to clients over the Internet. In this scenario, the client first tries to download the ontologies from the KDS. If this fails, it then tries the KIS. As such, in one embodiment, the virtual KC has (locally installed) all the ontologies that the KCs it federates has. 4. The client semantic runtime may intelligently manage memory usage for large ontology graphs. It may only cache large ontology graphs if there is available memory. In this embodiment, the following rules may be employed: i. If the ontology file is larger than 16 MB, the available physical memory threshold may be set at 512 MB (the client may only cache the ontology if there is at least 512 MB of physical memory available). ii. If the ontology file is between 8 MB and/or 16 MB in size, the available physical memory threshold may be set at 256 MB. iii. If the ontology file is less than 8 MB in size, the available physical memory threshold may be set at 128 MB. 5. The client semantic runtime may expose an API to the client Presentation engine (the Presenter), which may take one argument: the SourceUri of the item being displayed. The Presenter's semantic engine may then include the ObjectID and/or ProfileID of the containing request to the call to the client semantic runtime. 6. The API may return a list of Highlight Candidate Terms (HCTs). In the embodiment, this may be returned as an XML file. The XML can contain additional metadata for each HCT such as whether it is a keyword or category, or whether it is from an entity or document (etc.). The Presentation engine can then use this to highlight keywords and/or categories differently, and/or so on. 7. The HCT list may be generated as follows: i. In the embodiment, the HCT list XML file may be independent of any given result that is generated from the semantic query. However, in an alternative embodiment, especially if the HCT list is large (e.g., if a category in the semantic query is high up in the hierarchy of a large ontology), the client semantic runtime can retrieve the HCT list as follows: 1. It may first get the concepts (key phrases) of the result URI (for which highlighting terms are to be displayed) by calling the client-side concept extractor and/or categorizer (which is already part of the semantic client infrastructure for Dynamic Linking support—like Drag and/or Drop). This is an advantageous step as it avoids the need to return a large list of terms each time (especially for very broad categories high-up in the hierarchy). 2. For each key phrase, the runtime may check if the phrase matches ANY of the categories in the SQML representing the containing request. For each category, the runtime may walk the ontology graph and/or check if the key phrase is in the category's hooks table, is NOT in the category's exclusions table, is in any of the category's descendant hooks tables, and/or is NOT in any of the category's descendants' exclusions tables. 3. This algorithm may optimize for the smaller set (the key phrases in the document), rather than the [potentially] larger set (the ontologies). On average, this performs very well. This means that even for broad categories like Cancer and/or Neoplasm in the Cancer (NCI) ontology (perhaps with hundreds of thousands of hooks), the algorithm still performs O(N) where N is the number of concepts in the source document, NOT the number of terms in the broad category. ii. In one embodiment, terms for categories are obtained via the XPathNavigator. For each category in the SQML, XPath queries are used to find the hooks of the category and/or all its descendant categories. These terms are all added to the term list and/or annotated appropriately as having come from categories. iii. If the request involves Dynamic Linking (e.g., from Drag and/or Drop), the context may be first dynamically interpreted. The client first extracts the concepts in a domain (ontology)—independent way. In one embodiment, the client passes the extracted concepts directly to the KDSes for the KC in question (and/or does this for each KC in the profile in question—to get federated HCTs). The KDSes then return the category URIs corresponding to the concepts. In an alternative embodiment, the client passes the concepts to the KIS hosting the KC. The KIS then passes the concepts to the KDSes. Step ii above is then invoked for the categories. iv. The client may cache the categories for dynamic context so that if the user invokes the query again, a cache-hit may result in faster performance. The client holds on to the cache entry for floating text and/or flush the cache for documents or entities if the documents or entities change (before checking for a cache-hit, the client checks the last modified time-stamp of the document or entity. If there is a cache-miss, the concept extraction and/or categorization may be re-invoked and/or the cache updated. v. If there are keywords in the SQML, EACH keyword may be added to the term-list (the HCT list). vi. If there are exact phrases in the SQML, the exact phrases may be added to the term-list (the HCT list). 8. The client-side ontology graph may be updated periodically (for each subscribed KC). This may involve updating the ontology cache as the user subscribes to and/or unsubscribes from KCs. 9. Wire up the Ontology Graph Data Engine into the client runtime. This may involve a cache of the XPathDocument, XMLTextReader, ontology file size (to check for updates in the case of redirected or dynamically generated ontologies), ontology last modified file time (to check for updates), and/or the file path to the Ontology Cache. 10. Likewise for the server-side ontology graph (for each KDS). 11. When a semantic query/request is launched in the semantic client, the Presentation engine then may call the HCT extraction API, processes the XML results, and/or then highlights the terms in the Presenter (for titles, summaries, and/or the main body, where appropriate). Once this is done, the implementation may be complete (as currently specified). FIG. 14 illustrates an example of semantic highlighting.

KIS Indexing Pipeline. In one embodiment, the KIS has the following optimizations: More parallel pipelines to the KIS indexing system. This change now parallelizes indexing and/or I/O so that the KIS is able to index some documents while blocked on I/O from the KDS. This also allows the KIS to scale better with the number of CPUs. In an inefficient embodiment, for one KC, these operations would be serialized. This change could result in a 2-fold to 3-fold speedup in indexing performance on one server. Streamlining the KIS data model to remove redundant (or unused indexes). This improves indexing performance. Added KDS batching to the KIS. The KIS now folds calls to the same KDS from multiple ontologies into one call and/or marshals the inbound and/or outbound results (the marshaling cost is minimal compared to the I/O cost). This (in addition to the parallel pipeline change) resulted in a 4-fold speedup (on one server).

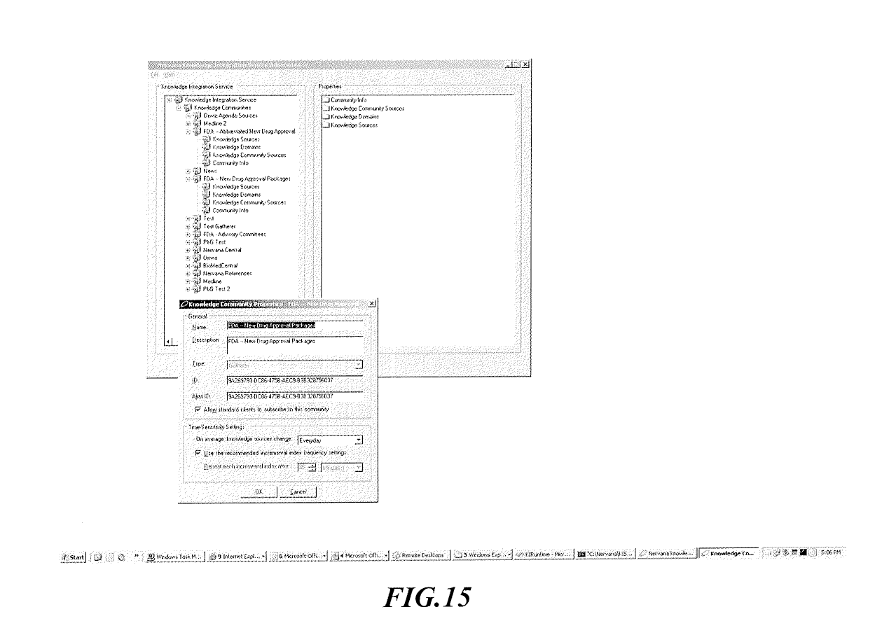

Additional KIS Features. FIG. 15 shows the KC Properties UI illustrating some additional admin-controllable features that have added to the KIS Screenshot Showing Additional KIS Features via KC Properties Dialog Box. The admin can select one of three types of KCs: Standard, Virtual Redirector, and/or Gatherer. The first refers to a regular KC and/or the second refers to a virtual KC. A virtual knowledge community is a KC that federates other (real) KCs. There are two kinds of virtual KCs: Redirectors and/or Mirrors. A redirector (currently supported) isn't real at all in that it has no data of its own. It merely reroutes queries from clients to real KCs and/or then merges the results on the fly. So it sits between—and/or “lies to”—both the client (the Librarian) and/or the real KCs. The Librarian thinks it is requesting results from a real KC and/or the real KC(s) think they are responding to the Librarian. As the name implies, a Mirror may be a synchronized copy of other (real) KCs. Mirrors would allow the admin to use some KCs mainly for indexing and/or then mirror the data on those KCs (with much less I/O overhead) to other KCs to be used primarily for query-processing. This model also allows the KIS to scale out as well as up, and/or to support large enterprise and/or online deployments. To avoid complexity and/or (potentially endless) recursion, a virtual KC cannot contain another virtual KC. Else (without very expensive and/or complicated distributed loop-detection), this could potentially result in an infinite request loop. The third option allows the admin to specify that a KC may only to be used to gather links based on the specified knowledge sources. This allows the admin to use the KC to, say, crawl web sites. The Gatherer KC then generates RSS based on the detecting links. The admin can then use the RSS in different ways: to transform the RSS (as described above), to index the RSS from another KC, etc. The admin can now specify the ID to be used with a newly created KC. This is a powerful feature especially for cases where the KIS database was restored or moved and/or the admin wants to restore the KC to use the same data store (the Semantic Metadata Store (SMS)). The admin can specify (and/or always change) the AliasID for the KC. This is what is used to identify the KC to clients. This is also very powerful because it means that clients don't need to re-subscribe to the KC if the KC is renamed. Also, if the server is reinstalled (or moved) and/or the KIS is restored, the KC can be recreated and/or set to use the same AliasID as before, thereby keeping the restoration or move process transparent to client subscribers. The admin can now specify whether the KC is to be visible to “standard clients.” “Standard Clients” refers to the end-user semantic client. This feature is useful in cases where the same KIS hosts standard client-accessible KCs and/or KCs to be used solely for the purpose of federation (within a larger virtual KC). However, all KCs remain visible to all other KCs—this allows a virtual KC to be able to point to any standard KC. The admin can specify time-sensitivity settings to indicate how often, on average, the knowledge sources change. In one embodiment, the following settings are available: Everyday (good for busy file-shares and/or high-traffic web sites and/or RSS feeds); Every week (good for weekly publications or not-so-busy content sources); Every two weeks (good for seldom busy content sources); Every month (good for journal publications); Every two months (good for journal publications); Every three months good for journal publications; Never (for archival sources). The admin can specify how often the KC re-indexes the knowledge sources. By default, the KIS recommends re-index frequencies based on the type of content source (e.g., 30 minutes for web sites, and/or 5 minutes for file-shares). The frequency can also change adaptively as the KIS observes the average data change rate. However, the admin can specify a frequency. This is advantageous especially for public web sites that might have specific instructions on how often they are be visited by crawlers.

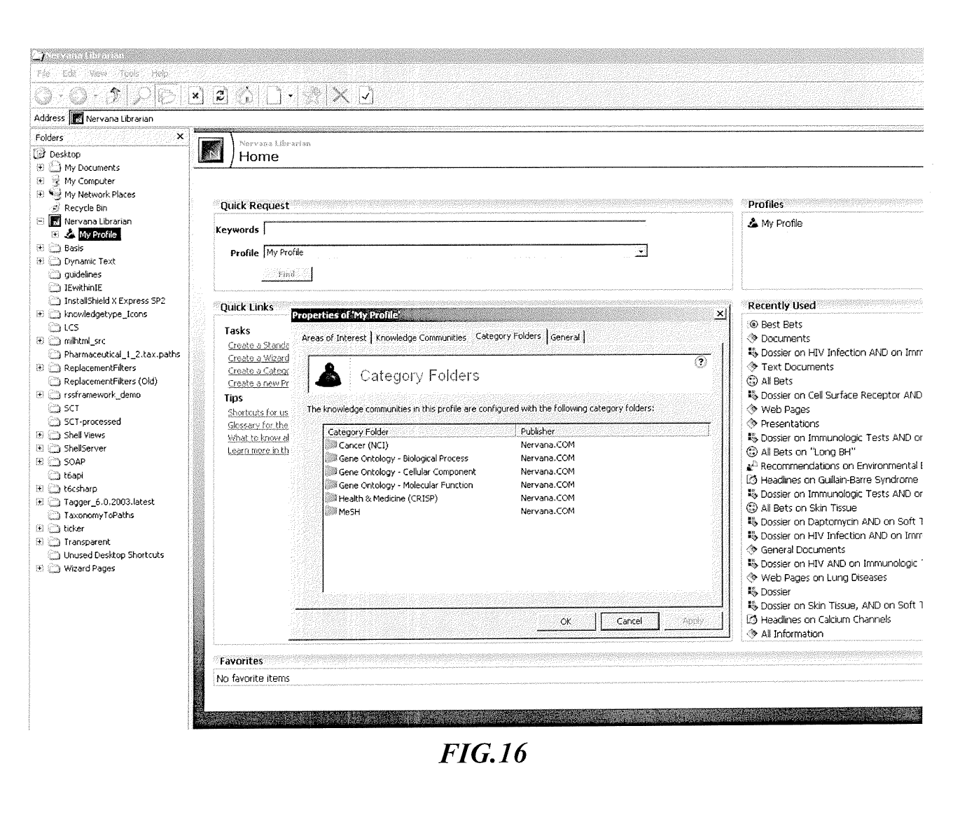

User Model for Determining Supported Ontologies. In one embodiment, a user of the semantic client (the Nervana Librarian) has a way of knowing which ontologies a KC “understands.” Else, it would be very easy for a user to pick categories from one of such ontologies, only to get 0 results. This could lead to user confusion because the user might think there is a problem with the system. To address this: 1. The SRML header may now include a field for “unsupported knowledge domains”—this field may have one or more knowledge domain GUIDs separated by a delimiter. 2. When the KIS receives a request, it may first check whether there are any unsupported knowledge domains in the SQML arguments—it does this by comparing the domains against the KDS domains it is configured with. If there are unsupported domains, it may populate the field and/or return the field in the SRML response. 3. If the SQML has the AND/OR operator and/or if number of unsupported knowledge domains is equal to the number of categories in the SQML argument, the server may return an error. If the operator is an OR and/or if the number of unsupported knowledge domains is equal to the number of arguments (categories, keywords, documents, etc.), the server may return an error. If at least one domain is supported, the server may process the request normally—as it does today; as such, the request may succeed but the unsupported field may also be populated. 4. On a per KC basis, and/or on getting the SRML response, if there is an error (appropriately tagged), the Presenter (in the semantic client) may display the error icon to indicate this. In one embodiment, there is a different icon for this—so the user clearly knows that the error was because of a semantic mismatch. 5. On a per KC basis, and/or on getting the SRML response, if there is no error (i.e., if at least one domain was supported), the Presenter may show the results but [also] displays the icon indicating that a semantic mismatch occurred. Perhaps this icon is smaller than the one displayed in #5 above (or has a different color) indicating that the error wasn't fatal. 6. When the user clicks on the icon, the Presenter may display an error message describing the problem. The Presenter may then call SRAPI (the semantic client's semantic runtime API) with a list of the unsupported domains (retrieved from the SRML header) to get the details of the domains. SRAPI may then return metadata on the domains—the Publisher and/or the category folder name—and/or this may be displayed as part of the error message. This way, the user may never see the GUID. 7. The semantic client also allows the user to browse the category folders (ontologies) a KC or profile supports. See, for example, FIG. 16, which shows support for this in the semantic client UI (the Nervana Librarian), in a screenshot Showing UI for Browsing Ontologies (Category Folders) in a User Profile (or KC).

Semantic Sounds. As described in co-pending application (U.S. patent application Ser. No. 11/127,021 filed May 10, 2005), the Information Nervous System would provide audio-visual cues to the user, based on the semantics of the request/results being displayed. Semantic Sounds are a new feature in line with this model. When in Live Mode and/or when there is Breaking News, the Presenter (in the semantic client) subtly notifies the user of Breaking News by making a sound. This signal is intelligent, based on the semantics of the news request. Here are some variables that affects the kind of sound that gets played: 1. The number of breaking news results—the alert is modulated based on this value (e.g., volume/amplitude, pitch, etc.) 2. How recent the news is (e.g., volume/amplitude, pitch, etc.) 3. How long ago the bell was sounded—similar to how Microsoft Outlook (the email client) only signals new mail after a while (it doesn't make redundant sounds as new email floods in). Also, in the future, these sound fonts can be extended to be different based on the semantics of the request. For instance, the bell for Breaking News in Aerospace might be the sound of a plane taking off or landing. The bell for Breaking News in Telecommunications might be the sound of ringing cell phones. The bell for Breaking News in Healthcare of Life Sciences might be the sound of a heartbeat. Also, in one embodiment, users would be able to customize and/or personalize Semantic Sounds.

Ontology Suggestions based on Public Search Engines (or Community Submissions) and/or Typos. An embodiment of the invention uses a synonym suggestion API (from public search engines—like Google Suggest) to suggest word and/or phrase forms for the ontology tool during the ontology development or maintenance process. This way, the system can piggyback on the collaborative filtering of public search engine users and/or their searches. This may be better than using something like Microsoft Word or WordNet which may provide the dictionary's perspective but not an aggregation of humanity's current perspective (which is what a good ontology represents). This, for example, may include slang words and/or the like, which we also want.

As an illustration, visit: http: //www.netcaptor.net/adsense/suggest.php

Typein:

1. Storage Area Network

2. XML

3. XPath

4. Web Service

5. Semantic Web

See the alternative forms.

For instance “Semantic Web” “Semantic Webbing” (sounds like a slang but is actually a good hook, given current lingo). The app is good at super-phrases that are PROPER phrases AND/OR that BEGIN with the typed word/phrase but does not address super-phrases that END or CONTAIN the typed word/phrase. Note that super-phrases may generally result in less false positives because they are more context-specific. Super-phrases are good to have even when the ontology has exact phrase hooks because without them, the categorizer can get biased by stop words which might be in the super-phrase. With super-phrase hooks, the stop words may have no effect and/or the entire super-phrase may get latched. See the PHP code here for the tool: http://www.netcaptor.net/adsense/_suggest_getter.txt. The live Google Suggest application is here: http://www.google.com/webhp?complete=1&h1=en. Because Google gives us the approximate results count for each suggestion, this is one way to prioritize your suggestions. Also, because Google Suggest only suggests super-phrases, I recommend the following algorithm (in one embodiment): 1. Call the API with the exact word/phrase; 2. Take out one letter. Repeat step 1 above; 3. Take out two letters. Repeat step 1 above; 4. Continue up till 3-5 letters (rough estimate). Repeat step 1 above. For example: calling the API with just “Laparoscopy” would miss “Laparoscopic.” However, typing “laparo” yielded “laparoscopic” AND/OR many more interesting suggestions which are also likely hooks.

“Laproscopy” also yielded results and/or is a common typo. Type this in Google, it asks whether you mean “laparoscopy.” To find reverse-recommendations from typos (likely typos, given the phrase), I recommend something like: 1. For all vowel letters, take out one vowel at a time and/or call the API (laparoscopy: lparoscopy, laproscopy, laparscopy, and/or so on . . . ) 2. For double-letters (e.g., ‘ll’), take out one letter and/or call the API (e.g., letter>leter) 3. If there is a hyphen (for compound names), take out the hyphen and/or call the API. 4. Launch Microsoft Word 2003 and/or go to Tools>Options. See the autocorrect rule list (that way we piggyback on typo research by Microsoft). Copy the rule list into a data store (like XML) and/or apply these rules. A closely related idea is Community Watch Lists. This is an offshoot of the Category Discovery feature wherein a Librarian user would have the option of viewing multiple watch lists:

Personal Watch Lists: My Default Watch List: this watch list may be populated with News Dossiers reflecting the default requests (with no context). My Favorites Watch List: this watch list may be populated dynamically based on the favorites list. My Live Watch List: this list may contain all requests that are currently set to Live Mode (whether or not they are favorite requests); this allows the user to dynamically watch (and/or “un-watch”) Librarian items. My Documents Watch List: this list may be dynamically built based on the categories (for all profiles) that correspond to the user's local documents, email messages, Web browser favorites, etc. The list may be built by a local crawler and/or indexer which may periodically crawl local documents, email, Web browser favorite links, etc. and/or find the categories by using Dynamic Linking on a per item basis. These categories may then be mapped to SQML and/or used to build this watch list. Community Watch Lists: Recommended Categories Watch List: this watch list may be automatically generated based on Recommended Categories in the user's knowledge communities (as described below). Popular Categories Watch List: this watch list may be automatically generated based on Popular Categories in the user's knowledge communities (as described below). Categories in the News Watch List: this watch list may be automatically generated based on Categories in the News, in the user's knowledge communities (as described below). Community Watch Lists may also be an extremely powerful feature as it would allow the user to track categories as they evolve in the knowledge space, further employing collective intelligence. You can think of this feature as facilitating Collective Awareness. In one embodiment, there may be My Favorites (favorites and/or live) and/or Community Favorites (all the Community watch lists, combined).

Category Discovery. Category Discovery is a new feature of an embodiment of the invention that would allow users discover new categories of interest. Today, while browsing for categories, the user has to know what categories are interesting to him/her. In many cases, this would map to the user's research interests, job title, etc. However, users occasionally want to find out about new areas. As such, we don't want a situation where the user remains “stuck in the same semantic universe” without expanding his/her knowledge to additional fields over time. To address this, an embodiment of the invention can perform mining of categories at each KIS. Each KIS may mine: 1. Recommended Categories—these are categories that the system recommends based on the user's interests and/or queries, and/or the semantic correlation between domains. This may be modeled based primarily on Categories in my Interest Group—these are categories relevant to people in the community that share the user's interests. Extremely popular categories (even outside my interest group) would also likely qualify. 2. Categories in the News—these are categories that are currently in the news; 3. Popular Categories—these are categories that are popular within a given knowledge community; 4. Best Bet Categories—these are categories that correspond to Best Bets within a given knowledge community. You can think of these filters as forming a Categories Dossier. A special filter, My Categories, is dynamically composed by mining the user's My Documents folder, local Web browser favorites, local email, etc. The user is able to specify local folders and/or information sources and/or Nervana profiles (all by default) to be used to determine the My Categories list. The semantic client would then periodically invoke Dynamic Linking to determine the user's category-oriented universe. This is very powerful as it allows the user to automatically determine his/her category universe (based on his/her information history) and/or then be able to use those categories in requests, entities, etc. Other filters can also be added, not unlike a Knowledge Dossier. The Librarian may then allow the user to view the categories dossier from within the Categories Dialog (the dialog may dynamically update the categories from each KIS in the user's profile(s)). Of course, as is the case today, the user may also be able to view “all categories.”

This feature may be very powerful. Imagine a new employee of Nervana that joins the company, subscribes to knowledge communities, and/or is eager to learn about various topics relevant to the organization (across context and/or time-sensitivity). Today, the employee would have to know which categories to browse for—likely categories relevant to his/her work. However, with Category Discovery (via a Categories Dossier), the employee may be able to discover new categories as the knowledge space evolves over time. And/or as is the case today, this discovery may be exposed in the context of one or more profiles, which could contain one or more knowledge communities—thereby resulting in Federated Category Discovery. This feature may apply collective intelligence not only to the discovery of documents and/or people but also to categories, which in turn represent an axis of discovery.

Category Discovery in Deep Info. Category Discovery also provides new “Deep Info portals or entry points.” In one embodiment, the Category Discovery filters are exposed via Deep Info. This is done on a per profile basis. An illustration is shown below:

```
[+] My Profile
    [+] Recommended Categories
        [+] Cancer
            [+] Amino Acids
                [+] Breaking News
[+] Headlines
                [+] Newsmakers
                [+] All Bets
                [+] Best Bets
                [+] Experts
                [+] Conversations
                    [+] Mary Smith
                        [+] Headlines
                    [+] Joe Johnson
                        [+] Interest Group
                        ...
                ...
            [+] Breaking News
[+] Headlines
                [+] Newsmakers
                [+] Best Bets
                [+] Conversations
                    [+] Peter Marshal
                    [+] Kenneth Falk
                    ...
                ...
    [+] Categories in the News
        [+] MeSH
            [+] Cardiovascular Diseases
                [+] Cardiac Failure
                ...
    [+] Popular Categories
    [+] Best Bet Categories
    [+] My Categories
    ...
...
```

Notice that the user is also (in addition to the discovered category) able to navigate from parents of the discovered categories (since they are also semantically relevant to the context). And/or as described in prior invention submissions, any of these “entity contents” can be dragged and/or dropped, copied and/or pasted, used with the Smart Lens. . . .

Legend:
Blue: Ontology (Category Folder) for discovered category
Red: Parent category for discovered category
Green: Discovered category

Knowledge Community Watch Lists. A closely related idea to Category Discovery is Knowledge Community Watch Lists. This is an offshoot of the Category Discovery feature wherein a Librarian user would have the option of viewing multiple watch lists:

Personal Watch Lists: My Default Watch List—this watch list may be populated with News Dossiers reflecting the default requests (with no context); My Favorites Watch List—this watch list may be populated dynamically based on the favorites list; My Live Watch List—this list may contain all requests that are currently set to Live Mode (whether or not they are favorite requests); this allows the user to dynamically watch (and/or “un-watch”) Librarian items; My Documents Watch List—this list may be dynamically built based on the categories (for all profiles) that correspond to the user's local documents, email messages, Web browser favorites, etc. The list may be built by a local crawler and/or indexer which may periodically crawl local documents, email, Web browser favorite links, etc. and/or find the categories by using Dynamic Linking on a per item basis. These categories may then be mapped to SQML and/or used to build this watch list. Community Watch Lists: Recommended Categories Watch List—this watch list may be automatically generated based on Recommended Categories in the user's knowledge communities (as described below); Popular Categories Watch List—this watch list may be automatically generated based on Popular Categories in the user's knowledge communities (as described below); Categories in the News Watch List—this watch list may be automatically generated based on Categories in the News, in the user's knowledge communities (as described below); Best Bet Categories Watch List—this watch list may be automatically generated based on Categories that correspond to Best Bets, in the user's knowledge communities. Knowledge Community Watch Lists may also be an extremely powerful feature as it would allow the user to track categories as they evolve in the knowledge space, further employing Collective Intelligence. You can think of this feature as facilitating Collective Awareness. In one embodiment, there may be My Favorites (favorites and/or live) and/or Community Favorites (all the Community watch lists, combined).

Part Mutual Cross-Ontology Validation and/or other Ontology Development and/or Maintenance Tool Features. In one embodiment, ontologies are developed and/or maintained with the help of ontology development and/or maintenance tools that aid the ontologist by recommending semantic assertions and/or other rules. For example, in one embodiment: Some category labels occur in multiple ontologies. The ontology tool flags the user (the ontologist) when there is a discrepancy. The discrepancy *might* be valid but might also indicate an incomplete ontology. For instance, Artificial Intelligence occurs in both IT and/or Products & Services but the sub-categories and/or hooks are likely very different. Some of this might be legitimate but some of it might be due to oversight. Similarly, Software occurs in both Products & Services and/or General Reference (ProQuest). Furthermore, hooks that occur in one domain probably allows exclusions in another domain (for instance, hooks for “Virus” in MeSH probably allows exclusions that are themselves hooks for “Virus” or “Computer Virus” in IT. And/or vice-versa. And/or so on. You can use the different ontologies to check for cross-domain mismatches of this sort. The inventor calls this Mutual Cross-Ontology Validation. It is an extremely powerful feature. This mutual cross-ontology validation approach may generate a viral network effect and/or positive feedback of ontological quality wherein as ontologies improve, others in the ontology network may also improve, which in turn may subsequently improve other ontologies . . . and/or so on . . . Also, hooks that have multiple word-forms probably includes exclusions and/or your tool flags this (not atypically, not all word forms applies in the same context). Ditto for hooks that occur in multiple domains—the cross-ontology validation described above, and/or the invocation of dictionaries like online search engines or tools like WordNet may help a lot here.

More on Semantic Inference Engine Types and/or Features. As may be described in the co-pending patent applications cited herein, the Semantic Inference Engine (SIE) may constantly be running, especially during the indexing process. The Time-Sensitivity Inference Engine (TSIE) may always be running as long as the service is running (because time “always runs”). The TSIE may determine what is “newsworthy” based on a triangulation of the context of the query (if any), time, and/or semantic strength. In one embodiment, only recommendations (“Good Bets” of strong, albeit not necessarily very strong, semantic density) constitutes newsworthy items (Breaking News or Headlines). However, the semantic query processor involves dynamic context-sensitive ranking such that the best headlines are returned before the next best, etc. This has been previously described but this note is aimed at proving yet another explanation. The SIE is responsible for adding semantic links for categories that are semantically related to categories that are returned during the categorization process. For instance, if the categorizer indicates that a document has the category “Encryption” with a score of 90 (out of 100), the SIE, in addition to creating a semantic link for this category, also creates a semantic link for parents of Encryption (e.g., Security). The SIE also optionally attenuates the scores as it moved up the hierarchy chain. This way, when a user semantic queries for a broad category, semantically related child categories are also found. This was described in the original invention but this note is aimed at providing a bit more insight. The Adaptive Ranking Inference Engine (ARIE) was described above.

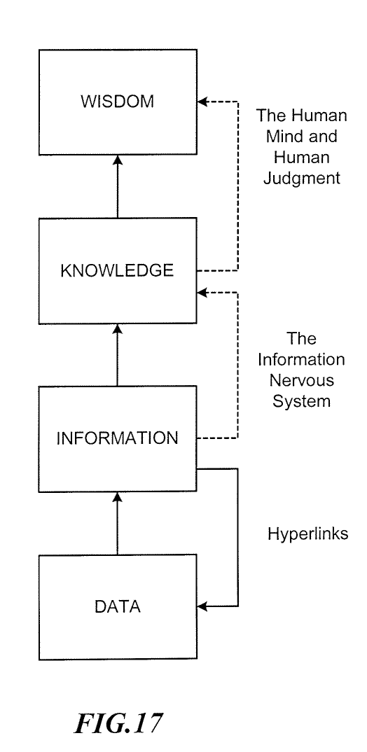

Semantic Business Intelligence. An embodiment of the invention can be used to provide Semantic Business Intelligence. Today, many Business Intelligence (BI) vendors provide reports on sales numbers, financial projections, etc. These reports typically are akin to Excel spreadsheets and/or usually have a lot of numerical data. One problem many BI vendors have today is that their users wish to ask semantic questions like: “What Asian market is the most promising for our localized products?” an embodiment of the invention provides the semantic infrastructure to approximate such natural queries. In one embodiment, the System handles this via its Semantic Annotation model, already described in the original invention submission. Business Intelligence Reports would get annotated with natural text and/or the associations are maintained via hyperlinks. An embodiment of the invention then semantically indexes the natural text annotations. Users then use the semantic client to ask natural questions. An embodiment of the invention returns the text annotations in the semantic client. The users can then interpret the context and/or also navigate to the BI reports via the hyperlinks. This model can be extended to any type of data or information, not just Business Intelligence reports. Audio, video, or any type of data or information can be annotated this way and/or semantically searched and/or discovered via an embodiment of the invention. FIG. 17 shows an illustration of the implementation of the feature, the well-known knowledge stack, and/or how this applies to this model.

Dynamic Ontology Feedback. Another feature of an embodiment of the invention is Dynamic Ontology Feedback. In one embodiment, there may be a button in the semantic client UI to allow the user to provide Nervana (or some third-party ontology intermediary) with ontology feedback via email. That way, our users can help improve the ontologies—since they, by definition, may be domain experts. The button can launch an email client (like Microsoft Outlook) preconfigured with an ontology feedback email address and/or a feedback form including the name of the ontology, the domain id, the request that triggered the response, the problem statement, etc. This can then feed to ontologies for processing and/or direct ontology improvement. In one embodiment, the semantic client may auto-fill the ontology feedback form with the details indicated above (since the semantic client may have that information on the client)—the user does not need to fill in anything. Also, ideally, there is a privacy statement for this so users can have the comfort that we are not sending any personal information back to Nervana or some third-party.

More on Dynamic Linking. One scenario that represents a common query in Life Sciences is the following: How does one find all proteins from Protein Database P relevant to abstracts on Inhibitor I found in the Medline database M? As previously described, the technology to enable this scenario, Dynamic Linking, is the essence of the invention. In Nervana, Dynamic Linking may allow the user to navigate across semantic (and/or ontological) boundaries at the speed of thought. This is what, like Knowledge itself, may make the system achieve a state of Endlessness—turning it into a true Nervous System. Drag and/or Drop, Smart Copy and/or Paste, the Smart Lens, Deep Info, etc. are some of the visual tools that may be used to invoke Dynamic Linking. In an embodiment the semantic client allows the user to drag a chemical compound image to Medline, find a semantically relevant abstract in Best Bets, copy a subscribed Protein Database KC (likely from a different profile) as a Smart Lens (via the Semantic Clipboard), hover over the Medline abstract using the Protein Database as the Smart Lens, and/or open a Dossier on the Medline abstract from the Protein Database on the chemical compound that initiated the [Semantic] Chain Reaction. By breaking up the problem into contextual sub-problems, Dynamic Linking allows the user to express semantic intent across contextual (and/or knowledge-source) boundaries ad infinitum. The system is then able to “answer” a complex question like the one above—the “question” is interpreted as a chain of smaller questions.

Handling Floating Text and/or Signaling in KIS Connectors and/or Data Source Adapters. As described in the KIS Connector Specification, RSS is used to abstract out different data sources (via DSAs that return RSS). In many cases, the information items to be indexed might not have any stored documents—they might be “floating text” (e.g., from databases that contain the item's text). In such a case, the DSA generates RSS with a Nervana-namespace qualified tag that indicates this. In one embodiment, this tag is called “nofollow.” Other uses for this are for cases where the KIS cannot index the full documents (when they do index) for administrative or business purposes. For example, the NIH web site typically forbids crawlers from indexing Medline documents. This feature would allow the metadata to be indexed even if the full documents can't be indexed. The sample RSS (from an embodiment's Medline metadata DSA) below illustrates this (the Nervana namespace is titled “meta”):

| | | | |
|---|---|---|---|
| − | <rss | version=“2.0” | xmlns:dc=“http://purl.org/dc/elements/1.1/” |

xmlns:meta=“http://schemas.nervana.com/xmlns/rss_2_0_meta.html”>

| | |
|---|---|
| − | <channel> |
| − | <item> |

<meta:robots>nofollow</meta:robots>
<title>Efficacy of current agents used in the treatment of Gram-positive

infections and/or the consequences of resistance.</title>

<pubDate>2005-04-06T00:00:00</pubDate>
<author>Segreti J</author>
<dc:language>eng</dc:language>
<dc:publisher>Clin Microbiol Infect</dc:publisher>
<description>The proportion of pathogens causing hospital-onset

infections that are resistant to antimicrobial agents continues to increase worldwide.
Inadequate antimicrobial therapy is an important factor in the emergence of resistance and/or
is associated with increased mortality. In the USA in 2000, the National Nosocomial
Infections Surveillance system reported that >50% of Staphylococcus aureus isolates
collected from intensive care units were resistant to methicillin (MRSA). The emergence of
community-acquired MRSA is a new concern. MRSA are associated with adverse clinical
outcomes and/or increased hospital costs. The increasing prevalence of MRSA contributes to
the use of glycopeptides; however, isolates with intermediate and/or full resistance to
vancomycin and/or teicoplanin are now being reported. Newer agents, such as the
oxazolidinone linezolid, are effective in the treatment of serious Gram-positive infections;
however, linezolid-resistant isolates of Enterococcus faecium, Enterococcus faecalis and/or
S. aureus have been reported. Therefore, there is an unmet clinical need for new agents with
activity against Gram-positive pathogens. Daptomycin, a lipopeptide with a novel mode of
action, was recently approved for the treatment of skin and/or soft tissue infections in the
USA. The two case studies presented herein detail experience with the use of daptomycin in
the USA.</description>

<link>http://www.ncbi.nlm.nih.gov:80/entrez/query.fcgi?cmd=Retrieve&db

=PubMed&dopt=Abstract&list_uids=15811022</link>

<meta:MetaTags>Rush Medical College, Department of Medicine, Section

of Infectious Diseases, Chicago, IL, USA., 15811022,</meta:MetaTags>

</item>
</channel>
</rss>

Semantic Question-Answering. One even more specific (than the semantic client and/or all its aforementioned inventions) application of an embodiment of the invention is Semantic Question-Answering. By this, I mean the ability of an embodiment of the invention to answer questions like: 1. What is the population of Norway? 2. Which country has the largest GDP in the European Union? A Natural-Language-Processing engine is described in at least one of the co-pending applications cited herein. In one embodiment, a Q&A layer is built on top of the Knowledge Integration Service (KIS) semantic query layer. Per the semantic query layer, for instance, a document that describes the population of Norway somewhere in its contents would get surfaced by the semantic engine in an embodiment of the invention. No additional annotations might be needed. Also, even if the factoid is written as “the number of people that live in the second largest Scandinavian country, an ontology that describes population and/or describes countries (in as many ways possible) would lead this factoid to be surfaced with an embodiment of the invention. This Q&A layer goes further and/or exposes specific answers as factoids. The Q&A layer involves annotating documents that are semantically indexed by the KIS. These annotations expose “facts” from text. These facts would then have schemas like People, Places, Things, Events, Numbers, etc. This may be an extension of the knowledge-stack model described in Part 22 above. The “factoids” may be akin to the Business Intelligence reports described above. Factoid reports with specific schemas may be annotated with natural text (and/or connected via hyperlinks). The semantic query layer in an embodiment of the invention would allow the user to retrieve the annotations. Once the user retrieves the annotations, the user may be able to view the factoids via hypertext. This model also allows multiple factoid perspectives to be exposed off the same document(s). This is extremely powerful and/or much richer than standard Q&A approaches that directly expose facts (while perhaps hiding other important viewpoints off the same document base).

Semantically Interpreting Natural Language Queries. At the beginning of at least one of the co-pending applications cited herein, I asserted that the notion of natural-language queries as the nirvana of information retrieval is wrong. I pointed out that discovery of knowledge, incorporating context-sensitivity, time-sensitivity, and/or occasional serendipity is instead possible. However, having the simplicity of natural language queries AS AN OPTION (drag and/or drop and/or other semantic tools are arguably more powerful in many contexts), WITHOUT the limitations of natural-language interpretation, is also possible. In other words, natural-language queries but NOT natural-language interpretation—rather, natural-language queries coupled with semantic interpretation in an embodiment of the invention. The power of coupling these is that the user can gain the simplicity of natural expression without losing the power of semantic discovery and/or serendipity. In one embodiment, the natural-language-query interpretation involves mapping the query to a Nervana semantic query. An NLP plug-in is added to the semantic client to do this. This plug-in takes natural-language input on the client and/or maps these to semantic input (SQML) before passing the query to the server(s) for semantic interpretation. The NLP component parses the natural-language text input and/or looks for key phrases using a standard key phrase extractor. The key phrases are then compared against the ontologies supported by the query profile. If any categories are found using direct, stemmed, and/or fuzzy matching, these categories are added to the semantic query as candidates. Key phrases that aren't found in the ontologies are proposed as keywords and/or stemmed variants are also proposed (and/or ORed in the SQML entry). The final candidates for semantic queries are then displayed to the user as recommended queries. The user can opt to choose one or more queries he/she finds consistent with his/her intent, or to edit the queries and/or then accept them. The accepted query (or queries) is then launched. This conversational model is very powerful because the reality is that the user might have a lot of background knowledge that would aid his/her interpretation of the natural-language-query and/or which an embodiment of the invention would not have. The reasoning system may be unable to always pick the right context and/or the ontologies might not capture the background knowledge. Background, experience, and/or memory also constitute context. And/or without “knowing” this, an embodiment of the invention may not do its job properly for arbitrary natural-language queries. As such, the conversational model allows an embodiment of the invention to propose semantic queries and/or then the user can then apply his/her background knowledge, experience, and/or “outside context” to further refine the query. This is a win-win. Examples of natural-language queries with corresponding semantic queries are: 1. Develop a genetic strategy to deplete or incapacitate a disease-transmitting insect population (from the Gates Foundation Grand Challenges on Human Health), Dossier on Genetics (MeSH) AND/OR Diseases or Disorders (CRISP) AND/OR Insects (MeSH) AND/OR ‘(transmit or transmits or transmission or transmissions or transmitting)’; 2. What is the cumulative effect of multiple pollutants on human health? (see http://www.tcet.state.tx.us/RFPS/Final_Reports/Bridges/Final%20Report.pdf); Dossier on Environmental Pollution (MeSH) AND/OR Public Health (MeSH); 3. What is the effect of pollution on learning in children? Dossier on Environmental Pollution (MeSH) AND/OR Learning Disorders (MeSH); 4. Are there cancer clusters in the Houston-Galveston area? All Bets on Neoplasm and/or Cancer (CRISP) AND/OR ‘Houston Galveston area’ 5. What are the long-term effects of fine particulate pollution on children?; Dossier on Pollutant (Cancer (NCI)) and/or Children (Cancer (NCI)); 6. How can one reduce exposure to pollution? Recommendations on Environmental Exposure (MeSH) and/or ‘reduce’ 7. What is the role of genetic susceptibility in pollution-related illnesses? Dossier on Diseases and/or Disorders (CRISP) AND/OR Environmental Pollution (MeSH) AND/OR Genetics (MeSH) The full list of Gates Foundation Grand Challenges on Human Health can be found at: http://www.grandchallengesgh.org/challenges.aspx?SecID=258. Here is the full list (these examples highlight the power of the Information nervous System and/or how keywords are completely ineffective): 1. Create effective single-dose vaccines that can be used soon after birth; 2. Prepare vaccines that do not require refrigeration; 3. Develop needle-free delivery systems for vaccines; 4. Devise reliable tests in model systems to evaluate live attenuated vaccines; 5. Solve how to design antigens for effective, protective immunity; 6. Learn which immunological responses provide protective immunity; 7. Develop a genetic strategy to deplete or incapacitate a disease-transmitting insect population; 8. Develop a chemical strategy to deplete or incapacitate a disease-transmitting insect population; 9. Create a full range of optimal, bioavailable nutrients in a single staple plant species. 10. Discover drugs and/or delivery systems that minimize the likelihood of drug resistant micro-organisms; 11. Create therapies that can cure latent infections; 12. Create immunological methods that can cure chronic infections; 13. Develop technologies that permit quantitative assessment of population health status; 14. Develop technologies that allow assessment of individuals for multiple conditions or pathogens at point-of-care; Take as an example challenge #7: Develop a genetic strategy to deplete or incapacitate a disease-transmitting insect population. With this multi-dimensional (multiple-perspectives) query, the difference in relevance between an embodiment of the invention and/or standard (non-semantic) approaches grows by orders of magnitude. Genetics is a huge field, there are many types of diseases, and/or there are many types of insects. And/or then to rank and/or group the results multi-dimensionally is extremely complex mathematically. An embodiment of the invention does this automatically.

Request Collections with Live Mode. Live Mode has already been described in details in at least one of the co-pending applications cited herein. This is just a note to qualify how Live Mode works with Request Collections (Blenders). When a Request Collection is in Live Mode, all its requests and/or entities, are presented live when the request collection is viewed. In one embodiment, the request and/or entities are not automatically made live themselves (if they are not live already). Only when the request collection is displayed are the requests viewed live (with awareness—ticker animations, etc. showing Breaking News, Headlines, and/or Newsmakers, etc.). A skin can elect to merge the results of a Request Collection so that only one set of live results may be displayed. Other skins might elect to keep the individual request collection entries viewed separately in Live Mode.

Adapting to Weak Categorization in Non-Semantic Context Templates. In some cases, some key phrases might not get detected in the categorizer, especially if the lexicon for the categorizer has not been seeded with the terms in the ontology. Typically, with rich enough context, this is not an issue because there is a high likelihood that terms in the ontology may already lie within key phrases. However, with short documents or abstracts, this might not happen because there might not be enough context. In this case, the ontology-independent concept extraction model can lead to weak categorization. To handle this, the categorizer is seeded with a lexicon corresponding to the terms in the ontology. This ensures that the categorizer, during the concept extraction phase, “knows” to return certain concepts based on the contents of its lexicon (now domain-specific). Furthermore, the KIS when interpreting semantic context with non-semantic context templates (like All Bets and/or Random Bets) AND/OR for a non-semantic ranking bucket (bucket #0), maps the category URI in the incoming SQML to keywords and/or include the keywords in the SQML resource inner join. This is powerful as it ensures that even if the categorization failed, the keyword that corresponds to the category name may result in a hit. There is a loss of semantics in moving to keywords but because the context template is All Bets or Random Bets AND/OR because the ranking bucket is non-semantic, this doesn't matter. This improves recall by dynamically adapting to a lack of context at the categorization layer.

Dynamic Linking Rules in the Server-Side Semantic Query Processor. The end-to-end architecture of Dynamic Linking (most typically invoked via Drag and/or Drop) has already been described in detail in at least one of the co-pending applications cited herein. This note is to clarify the supporting server-side implementation in the semantic query processor (SQP). At a high level, the philosophy of Dynamic Linking is that the system determines what the dragged is about and/or semantically retrieve items, in the context of the template of the dropped, from the source represented by the dropped. Once the semantic client retrieves the key concepts from the dragged (as has been previously described), it passes the metadata to the server(s) (possibly federated). Each server then asks the KDSes it is configured with to categorize the context. In an alternative embodiment, the client can directly contact the KDS to categorize the context and/or then pass the categories to the servers. The client has a concept extraction cache so it doesn't have to always extract concepts if the user repeats a query. And/or the server has a concept-to-categories cache (which it periodically purges) and/or use a ReaderWriter lock to maximize concurrency (since multiple client connections would be sharing the cache). The server then maps the weights in the categories to Best Bets, Recommendations, or All Bets, consistent with the weight ranges heuristics described in Part 6 above. The following rules are then applied in dynamically creating semantic queries in a semantic query chain (as described in at least one of the co-pending applications cited herein):

1. Query 1: For each Best Bet category in the source (if any), create a query with an AND/OR of all the categories; 2. Query 2: For each Recommendation category in the source that is NOT a Best Bet, create a query with an AND/OR of all the categories; 3. Query 3: If Query 1 had more than 1 category (i.e., if there was an AND/OR), for each Best Bet category in the source, create N queries with each category; 4. Query 4: If Query 2 had more than 1 category (i.e., if there was an AND/OR), for each Recommendation category in the source, create N queries with each category; 5. Query 5: For each Best Bet category in the source (if any), forward-chain by 1 up the hierarchy in the ontology corresponding to the category, and/or create a query with an AND/OR of the parent (forward-chained) categories. For instance, if there was a Best Bet on Encryption, forward-chain to the parent Security (in the same ontology) and/or AND/OR that with the other Best Bet parents. Check for (and/or elide as necessary) duplicates in case Best Bet categories share the same parent(s). NOTE: This rule entry may widen the scope of the semantic mapping. This is extremely powerful as it provides discovery (subject to semantic distance) in addition to precise semantic mapping. In one embodiment, forward-chaining is only be invoked if there are multiple unique parents. This is critical because ontologies are arbitrary and/or the KIS has no way of “knowing” whether even a semantic distance of 1 is “too high” for a given ontology (i.e., whether it may lead to semantic misinterpretation). In one embodiment, the threshold can be increased to 2 for Best Bets because there is a correlation between semantic strength and/or the probability of semantic distance resulting in false positives. In other words, Query 5 can then be repeated with a forward-chain length of 2 for Best Bets; 6. Query 6: For each Recommendation category in the source (if any) that is NOT a Best Bet category, apply the equivalent of Query 5. In one embodiment, the semantic distance threshold for forward-chaining with Recommendations (less semantic strength than Best Bets) is 1; 7. Query 7: For each All Bets category in the source that is NOT a Best Bet OR a Recommendation, create a query with an AND/OR of all the categories ONLY if there are eventually multiple unique categories (since All Bets also incorporates very low semantic density); 8. Query 8 (optional): If the source has less than N (configurable; 3 in one embodiment) keywords, add a keyword search query (since this would likely correspond to vacuous context that would then lead to weak mapping in Queries 1 through 7 above).

Lastly, the dynamically generated semantic queries are triangulated with the destination context template (Best Bets, Recommendations, etc.), and/or invoked using the sequential query model (previously described), with duplicate results eventually elided. The triangulation with the destination context template imposes yet another constraint to ensure that the uncertainty of the mapping rules are “contained” within the context of the destination template. So the context template eventually “bails out” the semantic and/or mathematical mapping from the “perils of uncertainty and/or complexity.” This is extremely powerful from both a mathematical and/or philosophical standpoint as it reduces an extraordinary complex mathematical space into discrete blocks and/or simultaneously honors the semantics of the query at hand. In one embodiment, the ontologies can also be annotated with hints indicating the how the Inference Engine in the KIS forward-chains to parents when performing Dynamic Linking. This may partially address the arbitrary semantic distance issue because the ontology author can indicate the level of arbitrariness for specific category nodes in the ontology. It wouldn't fully address the issue though because the arbitrariness might depend on the context of the semantic query, and/or this may not be known at ontology-authoring time.

Dynamic Client-Side Metadata Extraction for Dynamic Linking. As described in at least one of the co-pending applications cited herein, when an object (like a local or Web document or floating text) is dynamically linked on the semantic client, the conceptual (ontology-independent) metadata of the object is extracted and/or then sent to the federated KIS servers for dynamic semantic processing and/or mapping. However, in some cases, the full metadata for the “dropped or pasted object” might not be available to the semantic client at Dynamic Linking invocation time. A good (and/or common) example is a URL that is dynamically generated from metadata but which (at the presentation layer) does not contain all the metadata that might be semantically important. If the semantic client uses the presentation-layer data for Dynamic Linking, this might result in a loss of relevance because the client may not be employing all the metadata that corresponds to the object. To address this, in one embodiment, the System supports Dynamic Metadata Extraction (DME). There are two possible models:

1. Specified metadata per object: In this model, the KIS semantic index (the Semantic Metadata Store (SMS)) has a URL to an object (likely XML) that represents the metadata for each item in the index. This URL is then sent to the semantic client as part of SRML (via the SourceMetadataUri field, complementing the SourceUri field—which points to the object itself). The XML, in one embodiment, is in the SRML schema. When the object is then dragged and/or dropped (or copied and/or pasted or any other Dynamic Linking visual tool), the semantic client then extracts the aggregate metadata by accessing the object referred to via the SourceMetadataUri field. This aggregate metadata is then used for Dynamic Linking—as it represents the structured metadata for the object. In one embodiment, the aggregate metadata constitutes the coupling of the object (e.g., the contents of a document) itself and/or the metadata of the object. However, this model applies to objects that come from a KIS semantic index (i.e., objects that are SRML results).

2. Metadata Extraction Web Service (MEWS): In this model, the semantic client dynamically retrieves the metadata for an object by passing the URI (or contents, or hash, or concepts) of the object to a Metadata Extraction Web Service (MEWS). The MEWS then returns the SRML for the object from a Metadata Mapping Store (MMS). The MMS is maintained by the MEWS (and/or updated by an administrator) and/or maps an object to its metadata. The URL to the MEWS is configured at the KIS (for results that come from KISes) or at the semantic client (via Directory infrastructure—where the MEWS is a central content-management repository that is managed for a group of users).

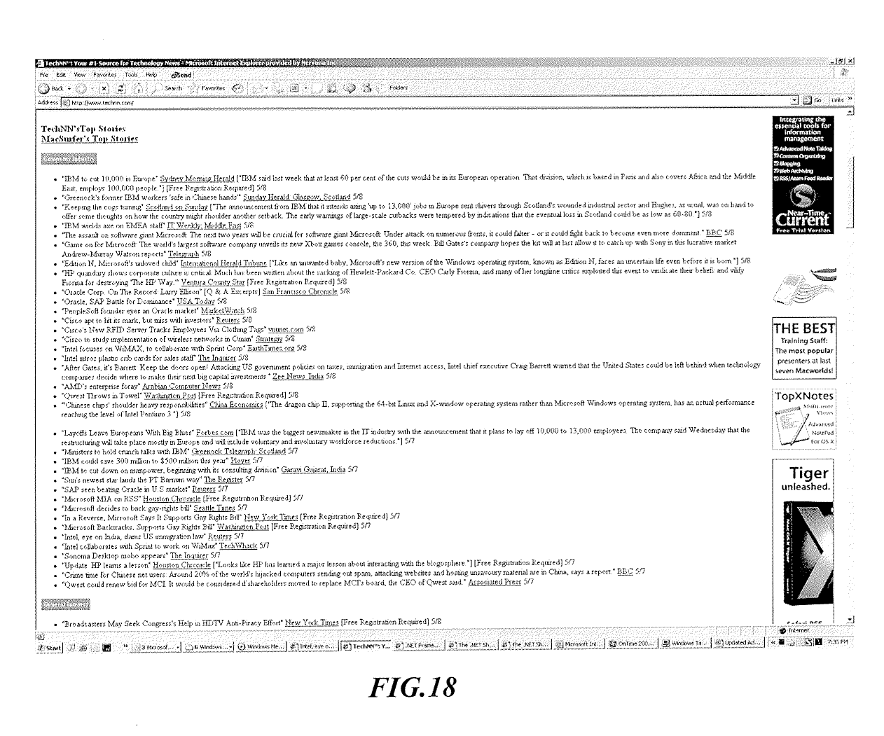

Smart Browsing. Smart Browsing refers to a feature of an embodiment of the invention that piggybacks on the Dynamic Linking infrastructure already described in at least one of the co-pending applications cited herein. FIG. 18 below illustrates what many Web users goes through today while trying to browse the World Wide Web. This is what I call the “Too Many Links” Problem. As I described in at least one of the co-pending applications cited herein, this arises from the lack of semantic intelligence in the World Wide Web platform. As information volumes continue to explode, there may be “too many links.” There is simply no way users may be able to navigate all the links that they would see in web sites as they browse. Smart Browsing is an application-layer feature that employs Dynamic Linking (in an embodiment of the invention) to specifically address this problem. With Smart Browsing, the semantic client would allow the user to load a Web page within the context of a System user profile. This then “places the Web page in context.” The semantic client already hosts a Web browser so loading a Web page would piggyback on this. When a Web page is loaded with Smart Browsing, the semantic client then invokes Dynamic Linking for the links on the Web page. It asks all the Knowledge Communities (KCs) in the selected profile to dynamically group the links. The KCs then return XML metadata indicating whether each link is a Best Bet, Recommendation, etc., based on the ontologies configured with the KCs. Furthermore, the XML metadata includes ranking information based on the ranking information that comes from the KISes' configured KDSes. The smart client then annotates each link (perhaps with different hyperlink colors, balloon pop-ups, etc.) with whether the link is a Best Bet in the context of the profile, a Recommendation, etc. In one embodiment, the semantic client might also rank each link based on the contextual semantic strength. This allows the user to know how to invest his/her time—by perhaps viewing the most important pages first, FOR THE SPECIFIED PROFILE. So the user can then view the same web page in different profiles and/or view the page differently with different contextual rankings per links. This is extremely powerful.

More on Client-Side Knowledge Communities. As described in at least one of the co-pending applications cited herein, I described client-side knowledge communities that would provide the user to ability to semantic search and/or discover knowledge from local information sources. This note is aimed at some added clarification: ALL the features of a server-side knowledge community would apply with a client-side knowledge community. Semantic processing of email, for instance, would employ the same model as previously described in the original invention submission. The same applies for all the context templates. For instance, the user may be able to find experts on specified context from his/her local email. The semantic processor would infer experts in the SAME WAY as with a server-side knowledge community.

Another Perspective on Experts, Newsmakers, and/or Interest Group Context Templates. An interesting way of thinking about Experts is as “Best Bets on the People Axis.” And/or Interest Group corresponds to “Recommendations on the People Axis.” And/or Newsmakers are “Headlines on the People Axis.” In one embodiment, “People” isn't viewed (semantically) as being radically different from “documents.” The Semantic Inference Engine (SIE) employs these philosophizations to provide a clean and/or logically coherent implementation of these context templates.

Intra-Entity Exploration in Deep Info. In at least one of the co-pending applications cited herein, I described how Deep Info would allow the user to semantically explore the knowledge space from any point of context. Entities are one such point of context. In one embodiment, Deep Info also applies to the contents of an entity (if any). For example, a “meeting entity” might have as its contents the participants of the meeting, the topics that were discussed during the meeting, the documents that were handed out during the meeting, etc. Intra-Entity Deep Info would allow the user to navigate within the entity and/or explore from there, in addition to navigating from the entity. And/or as described in at least one of the co-pending applications cited herein, any of these “entity contents” can be dragged and/or dropped, copied and/or pasted, uses with the Smart Lens, etc.

Ontology (Category Folder) Add-Ins. Ontology (Category Folder) Add-Ins is a powerful feature of an embodiment of the invention that allows the user to “plug in” a new ontology at the semantic client, even if that ontology was not installed with the client. This may be especially valuable in organizations that have their own private (or community) ontologies. In such cases, these ontologies may not come installed with the product.

The semantic client provides the infrastructure for Category Folder Add-Ins. An add-in is represented as an XML data blob as shown below:

```
        <?xml version=“1.0” encoding=“utf-8” ?>
        <ncfaml>
            <addins>
                <addin>
                    <domainid>3685f533-8b0d-4920-8c8f-
ca00df153239</domainid>
        <knowledgedomain>Onvia.COM/Onvia</knowledgedomain>
                    <publishername>Onvia</publishername>
                    <creator>Onvia</creator>
        <categoryfolderdescription></categoryfolderdescription>
                    <areasofinterest>
                        <areaofinterest>Products  &amp;
Services\Products</areaofinterest>
                        <areaofinterest>Products  &amp;
Services\Services</areaofinterest>
                    </areasofinterest>
        <taxonomyuri>\\nosa1\myshare\Onvia.txt</taxonomyuri>
                    <version>1.0</version>
                    <language>en</language>
                </addin>
            </addins>
        </ncfaml>
```

The XML file can contain multiple add-ins. An add-in has the following schema properties: DomainID: This uniquely identifies the ontology that corresponds to the add-in; KnowledgeDomain: The knowledge domain (virtual URI) for the add-in; PublisherName: The entity that published the add-in; Creator: The entity that created the add-in; CategoryFolderDescription: A description of the ontology or category folder; AreasOfInterest: The general areas of interest of the ontology or category folder; TaxonomyURI: A URL to the taxonomy file containing a list of paths to be used while displaying the taxonomy for the ontology in the Categories Dialog; Version: The version of the ontology or category folder; Language: The language of the ontology or category folder.

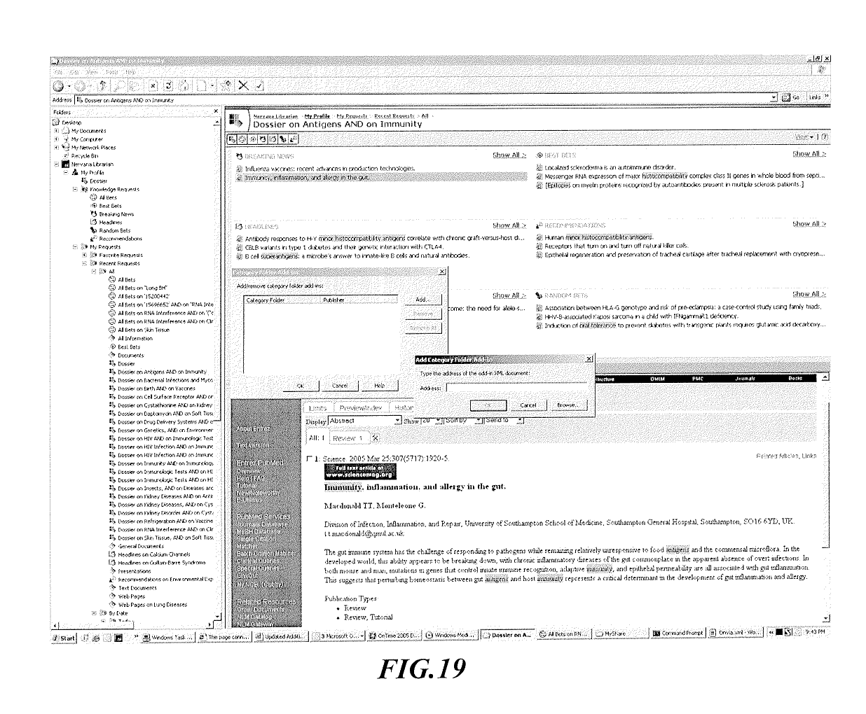

The semantic client exposes a user-interface to allow users to dynamically install or uninstall an add-in. The administrator (likely the publisher of the ontology) can publish the add-in XML file to a Web site or file share. Users can the install the add-in from there. When an add-in is installed, the semantic client downloads and/or caches the taxonomy file (for quick lookup during category browsing), and/or also registers the metadata in a local Ontology Metadata Store (OMS). This can be implemented via the System Registry. The user can then use the ontology pass though it came with the product. The ontology can then be later uninstalled. FIG. 19 illustrates the user-interface for installing and/or uninstalling Category Folder add-ins.

Boolean Keyword, Category, and/or Field-Specific Specifiers and/or Interpretation. In one embodiment, a System supports field-specific searches to supplement keyword searches. Examples are:

1. Author:“Long BH”; 2. PubYear:2003 OR PubYear:2004 OR PubYear:2005; 3. PubYear:2003-2005; 4. PubYear:1970-1975 OR PubYear:1980-1985 OR PubYear: 2000-2005 (anything published between 1970 and/or 1975, between 1980 and/or 1985 or between 2000 and/or 2005); 5. PubYear:2003 OR Author:“Long BH” (anything published in 2003 or authored by BH Long).

The KIS simply supports this with field-specific predicates (e.g., PREDICATETYPEID_AUTHOREDBY, PREDICATETYPEID_PUBLISHEDINYEAR, etc). This is already in the model, as described in at least one of the co-pending applications cited herein. Additional predicate types can be added to support schema-specific field filters (as described in at least one of the co-pending applications cited herein). The KIS Semantic Query Processor (SQP) then checks keywords for any field-specific annotations. If these exist, the specific predicate corresponding to the field is chosen in the inner sub-query. Else a more generic predicate (or a union of all keyword predicates) is chosen. Furthermore, categories can also be expressed using this model. Examples are:

MeSH:“CardioVascular Diseases”

Cancer:“Tyrosine Kinase Inhibitor”

The KIS similarly maps these to category predicates using the appropriate category URI, based on the ontology specified in the annotated keyword. An embodiment of the invention may also allow the user to specify cross-ontology categories. For example, the specifier *:Apoptosis may be mapped (by the KIS) to the semantically densest category (best-performing) or ALL categories with that name (highest relevance), depending on admin settings. This is very powerful as it provides better discovery and/or semantic relevance by looking at multiple ontologies simultaneously. Lastly, these specifiers can be combined using Boolean logic. One example is listed above: PubYear:1970-1975 OR PubYear:1980-1985 OR PubYear: 2000-2005 (anything published between 1970 and/or 1975, between 1980 and/or 1985 or between 2000 and/or 2005). Any of the specifiers can be combined (keywords or categories). So a user can write PubYear:1970-1975 OR MeSH:Cardiovascular Diseases OR Cancer:Tyrosine Kinase Inhibitor OR *:Apoptosis (anything published between 1970 and/or 1975, or about Cardiovascular Diseases in MeSH or about Tyrosine Kinase Inhibitors in Cancer or about Apoptosis in all supported ontologies). An intersection (AND/OR) can also be specified as can AND/OR NOT and/or other Boolean logic specifiers. The KIS simply maps these to either sequential sub-queries for logical consistency (as previously described) or to a broader SELECT statement in the OBJECTS table before the inner join—typically using the IN keyword (multiple specifiers) instead of the =operator (single specifier).

Uncertainty, Mathematical Complexity, and/or Multi-Dimensionality. In at least one of the co-pending applications cited herein, I contrasted an embodiment of the invention from the Semantic in numerous ways. One of these ways was the requirement of tagging in the Semantic Web. In my comments, I placed a lot of emphasis on the “need for discipline” on the part of the authors, arguing that this model (tagging) could not scale. I maintain my position on this I am merely writing to buttress my original argument. In addition to the “need for discipline,” the Semantic Web approach also fails to take into account the inherent uncertainty in many semantic assertions. Many assertions may be probabilistic and/or the probabilities may be conditional probabilities that are themselves dependent on context. And/or such context is typically chained to more contexts. As such, the requirement of tagging in an environment of uncertainty (dealing with human expression) is impractical at scale. Indeed, “uncertainty” is why the word “Bet” is used a lot in the Information Nervous System. The system is built to assume (rather than avoid) uncertainty. Furthermore, there is the element of mathematical complexity in the tagging process. Let us take an example research question listed above: Develop a genetic strategy to deplete or incapacitate a disease-transmitting insect population. With an embodiment of the invention, the user may be able to approximate this question with the semantic query: Dossier on Genetics (MeSH) AND/OR Diseases and/or Disorders (CRISP) AND/OR Insects (MeSH). And/or one of the entries in the Dossier is Best Bets on Genetics (MeSH) AND/OR Diseases and/or Disorders (CRISP) AND/OR Insects (MeSH). If one was to ask humans to manually tag the most semantically relevant ACROSS all three dimensions specified in the query, and/or against millions or billions of documents (and/or incorporating uncertainty and/or multi-dimensionality), the impracticality of tagging from a mathematical complexity perspective becomes even more evident.

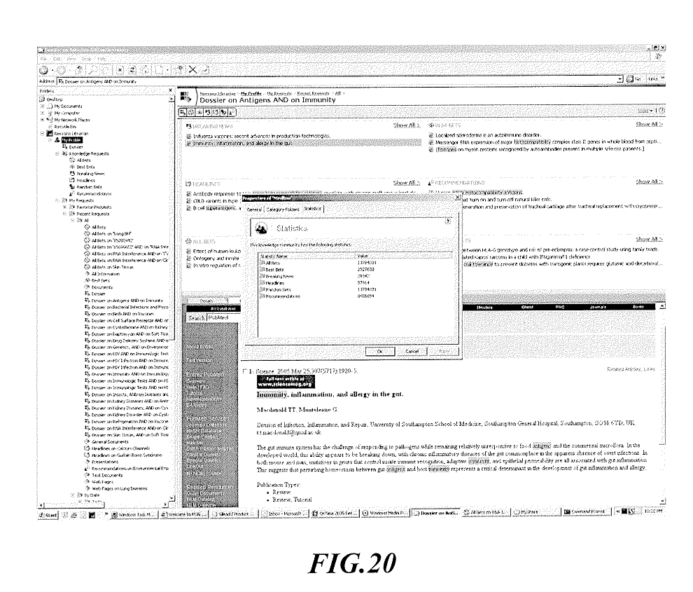

Viewing Knowledge Community Statistics in the Semantic Client. An embodiment of the invention now allows the user to view Knowledge Community (KC) statistics from the semantic client. The KIS exposes a Web Service API to query statistics. The semantic client calls this API in response to a UI invocation on a per-KC basis. Statistics include the results count per context-template. Additional statistics can be added. FIG. 20 illustrates an example of this. The Information Overload Crisis. More data has been generated between 1999 and/or 2002 than that generated in all of the pharmaceutical industry's history.“(Source: DrugResearcher.com); 903,652 new/modified Medline abstracts in 2005 alone (˜7000/day). Information doubling yearly (Forrester, U.C. Berkeley); Increasing data fragmentation: virtual, distributed, global research and/or development; numerous data sources; Semantic complexity and/or fragmentation, increasingly complex vocabulary, new gene names, compound names; arbitrary naming schemes; fragmented vocabularies. “The problem is that data is trapped in hierarchical silos, restricted by structure, location, systems and/or semantics. The situation has become a data graveyard.”—Sheryl Torr-Brown, Head of Knowledge Management and/or Technology, Worldwide Safety Sciences at Pfizer. Knowledge, not information, is what drives productivity. One definition of knowledge is “information infused with semantic meaning and/or exposed in a manner that is useful to people along with the rules, purposes and/or contexts of its use.” Search engines lack semantics and/or context and/or are unequipped to handle information overload. The problem with search is:

Goal should be search+discovery

“I don't know what I don't know”

Contextual guidance

Search along multiple contextual axes

Semantics, time, context, people

Search across semantic boundaries

Physical and/or semantic fragmentation

A lot of research is inter-disciplinary

Nervana formulation:

Search engines search for i (information)

Goal should be to find K (Knowledge)

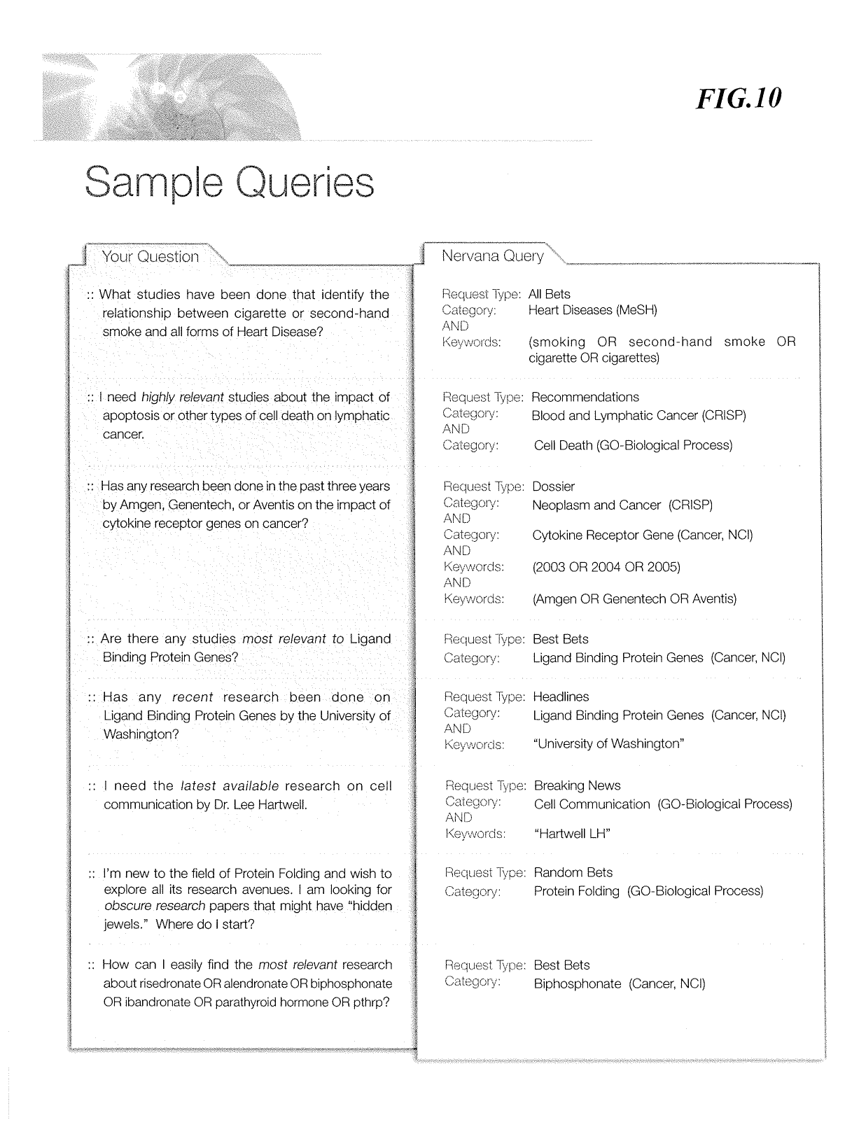

Sample Research Questions (Gates Foundation Grand Challenges in Human Health) include: Develop a genetic strategy to deplete or incapacitate a disease-transmitting insect population; Develop a chemical strategy to deplete or incapacitate a disease-transmitting insect population; Create a full range of optimal, bio-available nutrients in a single staple plant species; Discover drugs and/or delivery systems that minimize the likelihood of drug resistant micro-organisms. (Texas Council of Environmental Technology): What is the role of genetic susceptibility in pollution-related illnesses? Which clinical trials for Cancer drugs employing tyrosine kinase inhibitors just entered Phase II? What are my top competitors doing in the area of Cardiovascular Diseases? Patents, News, Press Releases, etc.? Find the top experts researching Genes relating to Mental Disorders. An embodiment of the invention solves this problem by way of different contextual axes: Common but different scenarios, Examples: All Bets, Best Bets, Breaking News, Headlines, Recommendations, Random Bets, Conversations, Annotated Items, Popular Items, Experts, Interest Group, and/or Newsmakers. Special Knowledge Filter: Dossier. Filter of filters. E.g., Dossier on Cardiovascular Disorder: Breaking News on Cardiovascular Disorder; Experts on Cardiovascular Disorder, etc. Since filtering is on multiple axes, ranking can be “good enough.” Mathematical complexity, uncertainty in ontological expression, imperfect ontological context, multiple semantic paths, probabilistic but sufficiently different to be valuable, navigating knowledge filters=navigating knowledge. The problem with keywords is they are a very poor approximation of semantics. Poor precision and/or recall. “Cancer”=disease, public policy issue, genetics? “Cancer”=Adenoma, carcinoma, epithelioma, mesothelioma, sarcoma? For example, suppose you want to find all papers on Cancer written by Nobel Prize winners. Not search for “cancer”+“nobel prize” should return articles on carcinoma by Lee Hartwell (2001); articles on sarcoma by Peter Medawar (1960). Multi-dimensional precision and/or ranking. Best results in multiple dimensions. Another example would be, “Find all papers on Cardiovascular Disorder and/or Protein Engineering and/or Cancer,” not a search for “cardiovascular disorder”+“protein engineering”+“cancer” should include: technical articles on Hypervolemia and/or Amino Acid Substitution and/or Minimal Residual Disease, etc. Recall divergence increases EXPONENTIALLY with query complexity. The problems with other forms of context are that keywords are not enough. Topics, documents, folders, text, projects, location, etc.; contextual combinations. Examples include: Find all articles on Cell Division (topic); Find Experts on this presentation (document); Find all articles on Cell Division (topic) and/or “Lee Hartwell” (keywords); Nervana formulation: K(X), where K is knowledge and/or X is context (of varying types); Context-sensitive ranking on X by K. Google™ mines Hypertext links to infer relevance. “PageRank” is a very clever technique, effective enough for large-scale Hypertext Web, but no context. Articles on Cancer by Nobel Prize winners is not Popular Pages+“cancer”+“Nobel prize”. Popular garbage is still garbage. PageRank relies on the presence of links and/or most enterprise documents do not have links, for example: Adobe™ PDF, Microsof™ Office documents, content management and/or popularity is only one axis of relevance. Google™ relies on a centralized index. The knowledge is fragmented, security silos, semantic silos. Nervana formulation: K(X) from S1 . . . Sn, where K is Knowledge, X is polymorphic context, and/or Sn is a semantically-indexed knowledge base; Context-sensitive ranking on X, by K. The Problem with “Natural Language” Search. Search vs. Discovery Language interpretation is NOT the same as semantic interpretation, it does not address multiple forms of context. The problem with Directories and/or Taxonomies. 1:1 vs. 1:many; documents to topics; single vs. multiple perspectives, Static vs. dynamic; Research often crosses domain boundaries; Nervana formulation: Natural-language Q&A flexibility without natural-language queries; K(X) from S1 . . . Sn, where K is Knowledge, X is polymorphic and/or dynamically combined context, and/or Sn is a semantically-indexed knowledge base; Context-sensitive ranking on X, by K. More metadata and/or semantic markup, RDF. Ontologies: OWL. Problems include reliance on formal markup and/or metadata; impractical at scale; expressing uncertainty; conditional Probabilities? Mathematical complexity and/or multi-dimensionality: absence of context at markup time; Limitations of human expression; does not address hard problems of semantic indexing, filtering, ranking, and/or user-interface. Most knowledge-related questions are semantic not structural. Witness Google™'s success (no reliance on structure). Multiple perspectives of meaning. Find all articles on Cancer written by Nobel Prize Winners. Question crosses “semantic boundaries”, Notion of a formal “Web”, “Web” is author-centric, not user-centric, Navigation should be dynamic (across silos); “Web” should be virtual. For example, “navigation” from local document to Experts on that document. Semantic query processing; Across ontology boundaries; Context-sensitive; Semantic dynamism; Semantic user interface; Multiple schemas; Flexible knowledge representation; Integrated data model; Domain-specific and/or domain-independent; Inference and/or reasoning. The Nervana Knowledge Domain Service (KDS). Dynamic ontology-based classification. The Nervana Knowledge Integration Service (KIS). Semantic indexing and/or integration; does not require semantic markup; exploits structured metadata if available; multiple distributed ontologies; separates data from semantic interpretation; multiple perspectives; inference and/or Reasoning Engine; dynamic linking (semantic dynamism); semantic user experience without needing a Semantic Web. See, for example, FIGS. 5 and/or 8. The Nervana Librarian (Semantic User Interface) features User Intent, Context and/or semantics, Time-sensitivity, Discovery, Multiple knowledge axes, Semantic cross-fertilization, Personalization, Federation, Other: Awareness, Attention-management, Dynamic follow-up and/or drill-down, Seamless integration with context and/or workflow, Discoverability of knowledge, Knowledge capture and/or sharing and/or context sharing and/or collaboration. See FIG. 7. K(X) from S1 . . . Sn, where K is Knowledge, X is polymorphic and/or dynamically combined context, and/or Sn is a semantically-indexed knowledge base; Multi-dimensional, context-sensitive ranking on X, by K. Implications: Knowledge filters+semantic user interface+dynamic semantic indexing and/or query processing=approximation for natural-language queries. Triangulation of knowledge filters+context+sources=semantic approximation. Example: Find all articles on Cancer written by Nobel Prize Winners˜=Dossier on Cancer (Life-Sciences ontology) AND/OR Nobel Prize Winners (General Reference ontology); Knowledge filters soften impact of imperfections in predicate interpretation, ontologies, and/or categorization; E.g., “By” vs. “On”; Filters provide diverse and/or approximate semantic paths. See, for example, FIG. 9. There is increasing pressure on the industry to improve R&D ROI, one major cause: Information Overload. Limitations of current solutions are: Knowledge vs. Information; Search vs. Discovery, Context and/or Semantics. Introduced the Nervana System (the Information Nervous System) which includes end-to-end knowledge medium; context, semantics, dynamic linking, a semantic user interface; a semantic user experience without semantic markup or a Semantic Web; approximation for natural-language queries (with Discovery and/or without its limitations).

Category result (via ontology) returned by KDS:
Name: Cardiovascular Disorder Epidemiology
URI: nerv://76331eb3-e494-45b5-8939-
a4db68bea4bd?type=category&path=Biology/Ecology/Human
Ecology/Human
Population Study/Epidemiology/Cardiovascular Disorder Epidemiology
Weight: 0.431
Category object schema:
Name: Cardiovascular Disorder Epidemiology
URI: nerv://76331eb3-e494-45b5-8939-
a4db68bea4bd?type=category&path=Biology/Ecology/Human
Ecology/Human Population Study/Epidemiology/Cardiovascular Disorder
Epidemiology
ObjectID: 3498

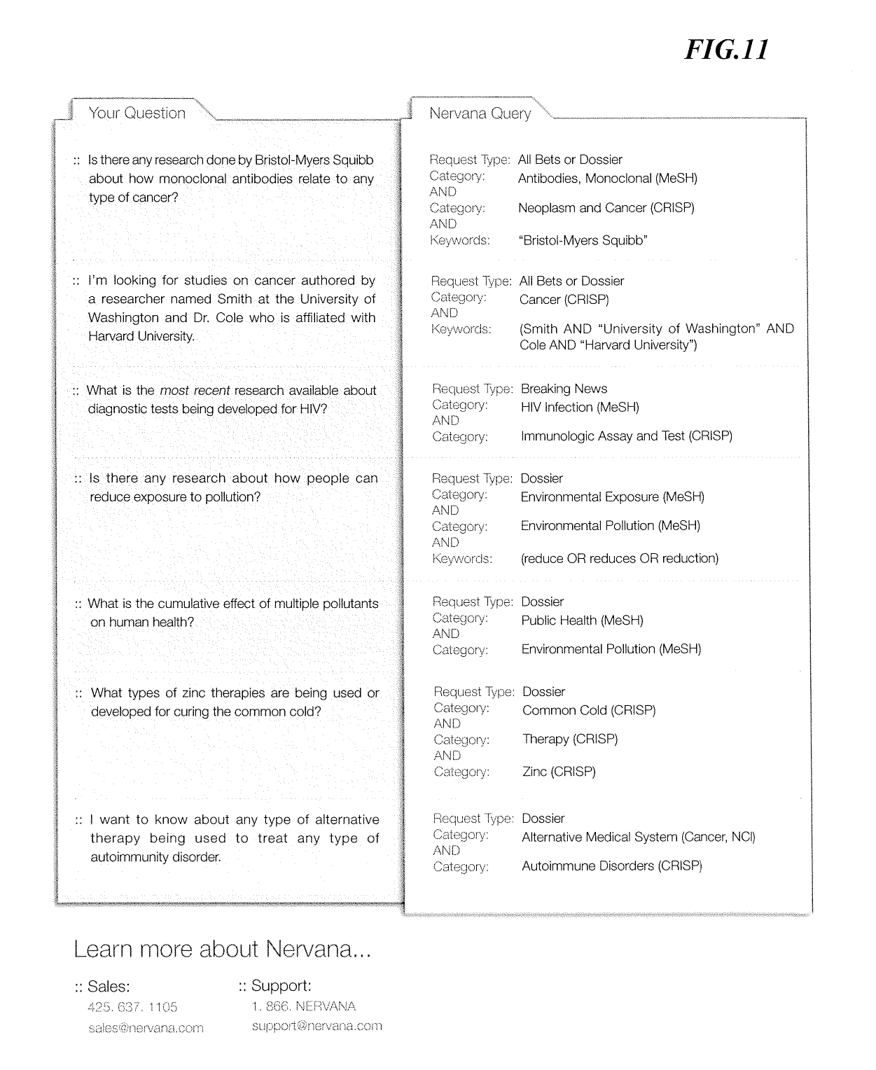

See, for example, Sample Queries—FIGS. 10 and/or 11.

While the preferred embodiment of the invention has been illustrated and/or described, as noted above, many changes can be made without departing from the spirit and/or scope of the invention. Accordingly, the scope of the invention is not limited by the disclosure of the preferred embodiment. Instead, the invention should be determined entirely by reference to the claims that follow.

The embodiments of the invention in which an exclusive property or privilege is: claimed are defined as follows:

1. A system for knowledge retrieval, management, delivery and/or presentation, comprising:
a server programmable to maintain semantic information; and/or
a client providing a user interface for a user to communicate with the server,
wherein the processor of the server operates to perform the steps of:
securing information from information sources;
semantically ascertaining one or more semantic properties of the information; and/or
responding to user queries based upon one or more of the semantic properties.
